(19) United States
(12) Patent Application Publication
(10) Pub. No.: US 2024/0283618 A1
(43) Pub. Date: Aug. 22, 2024

(54) TBS DETERMINATION IN SIDELINK TRANSMISSION

(71) Applicant: Samsung Electronics Co., Ltd., Suwon-si (KR)

(72) Inventor: Hongbo Si, Allen, TX (US)

(21) Appl. No.: 18/428,960

(22) Filed: Jan. 31, 2024

Related U.S. Application Data
(60) Provisional application No. 63/446,241, filed on Feb. 16, 2023.
(60) Provisional application No. 63/454,554, filed on Mar. 24, 2023.
(60) Provisional application No. 63/461,428, filed on Apr. 24, 2023.
(60) Provisional application No. 63/524,743, filed on Jul. 3, 2023.

(51) Int. Cl. H04L 5/00; H04W 72/40

(52) U.S. Cl. CPC H04L 5/0092; H04W 72/40

(57) ABSTRACT

Apparatuses and methods for transport block set (TBS) determination in sidelink transmission. A method of a user equipment (UE) includes determining, based on higher layer parameters, a number of candidate starting symbols for a physical sidelink shared channel (PSSCH) in a slot; determining a number of sidelink symbols within a slot based on the number of candidate starting symbols for the PSSCH; and determining, based on the number of sidelink symbols, a first number of resource elements (REs) allocated for the PSSCH within a physical resource block. The method further includes determining a number of PRBs allocated for the PSSCH; determining a second number of REs allocated for the PSSCH based on (i) the number of REs allocated for the PSSCH within a PRB and (ii) the number of PRBs allocated for the PSSCH; and receiving the PSSCH based on the second number of REs allocated for the PSSCH.

### CROSS-REFERENCE TO RELATED APPLICATIONS AND CLAIM OF PRIORITY

The present application claims priority under 35 U.S.C. § 119(e) to U.S. Provisional Patent Application No. 63/446,241 filed on Feb. 16, 2023, U.S. Provisional Patent Application No. 63/454,554 filed on Mar. 24, 2023, U.S. Provisional Patent Application No. 63/461,428 filed on Apr. 24, 2023, and U.S. Provisional Patent Application No. 63/524,743 filed on Jul. 3, 2023, which are hereby incorporated by reference in their entirety.

### TECHNICAL FIELD

The present disclosure relates generally to wireless communication systems and, more specifically, to methods and apparatuses for transport block size (TBS) determination in sidelink transmissions.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to methods and apparatuses for TBS determination in sidelink transmissions.

In one embodiment, a user equipment (UE) in a wireless communication system is provided. The UE includes a processor configured to determine, based on higher layer parameters, a number of candidate starting symbols for a physical sidelink shared channel (PSSCH) in a slot; determine a number of sidelink symbols (N_{symb}^{sh}) within a slot based on the number of candidate starting symbols for the PSSCH; determine, based on the number of sidelink symbols, a first number of resource elements (REs) (N_{RE}′) allocated for the PSSCH within a physical resource block (PRB); determine a number of PRBs (n_{PRB}) allocated for the PSSCH; and determine a second number of RES (N_{RE}) allocated for the PSSCH based on (i) the first number of REs allocated for the PSSCH within the PRB and (ii) the number of PRBs allocated for the PSSCH. The UE further includes a transceiver operably coupled to the processor. The transceiver is configured to receive the PSSCH based on the second number of REs allocated for the PSSCH.

In another embodiment, a method of a UE in a wireless communication system is provided. The method includes determining, based on higher layer parameters, a number of candidate starting symbols for a PSSCH in a slot; determining a number of sidelink symbols (N_{symb}^{sh}) within a slot based on the number of candidate starting symbols for the PSSCH; and determining, based on the number of sidelink symbols, a first number of RES (N_{RE}′) allocated for the PSSCH within a PRB. The method further includes determining a number of PRBs (n_{PRB}) allocated for the PSSCH; determining a second number of RES (N_{RE}) allocated for the PSSCH based on (i) the number of REs allocated for the PSSCH within a PRB and (ii) the number of PRBs allocated for the PSSCH; and receiving the PSSCH based on the second number of REs allocated for the PSSCH.

Other technical features may be readily apparent to one skilled in the art from the following figures, description, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4 and 5 illustrate an example of a wireless transmit and receive paths according to embodiments of the present disclosure;

FIG. 6 illustrates a diagram of a resource pool in Rel-16 NR V2X according to embodiments of the present disclosure;

FIG. 7 illustrates diagrams of slot structures for SL transmission and reception according to embodiments of the present disclosure;

FIG. 8 illustrates diagrams of PSCCHs and PSSCHs subject to a starting symbol according to embodiments of the present disclosure;

FIG. 9 illustrates a flowchart of a UE procedure for determining the number of REs for PSSCH in a RB according to embodiments of the present disclosure;

FIG. 10 illustrates a diagram of a PSSCH for wideband scenario according to embodiments of the present disclosure;

FIG. 11 illustrates a flowchart of a UE procedure for determining the number of PRBs for PSSCH according to embodiments of the present disclosure;

FIG. 12 illustrates a diagram of example cases for a first type of CP extension according to embodiments of the present disclosure;

FIG. 13 illustrates a diagram of example cases for a second type of CP extension according to embodiments of the present disclosure;

FIG. 14 illustrates a flowchart of an example UE procedure according to embodiments of the present disclosure.

### DETAILED DESCRIPTION

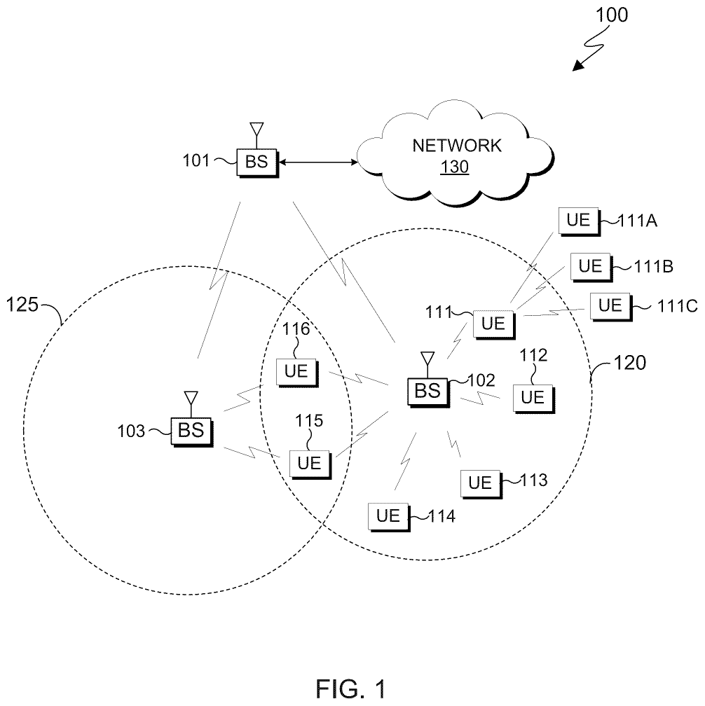

FIGS. 1-14, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: 3GPP TS 38.211 v17.1.0, “NR; Physical channels and modulation” (herein, “REF 1”); 3GPP TS 38.212 v17.1.0, “NR; Multiplexing and channel coding” (herein, “REF 2”); 3GPP TS 38.213 v17.1.0, “NR; Physical layer procedures for control” (herein, “REF 3”); 3GPP TS 38.214 v17.1.0, “NR; Physical layer procedures for data” (herein, “REF 4”); and 3GPP TS 38.331 v17.1.0, “NR; Radio Resource Control (RRC) protocol specification” (herein, “REF 5”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

Depending on the network type, the term “base station” or “BS” can refer to any component (or collection of components) configured to provide wireless access to a network, such as base transceiver station, a radio base station, transmit point (TP), transmit-receive point (TRP), a ground gateway, an airborne gNB, a satellite system, mobile base station, an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone, smartphone, monitoring device, alarm device, fleet management device, asset tracking device, automobile, etc.) or is normally considered a stationary device (such as a desktop computer, entertainment device, infotainment device, vending machine, electricity meter, water meter, gas meter, security device, sensor device, appliance, etc.).

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of gNB 101, gNB 102 and gNB 103 may support TBS determination in sidelink transmissions as described in embodiments of the present disclosure. In some embodiments, one or more of UEs 111-116 may perform TBS determination in sidelink transmissions as described in embodiments of the present disclosure.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

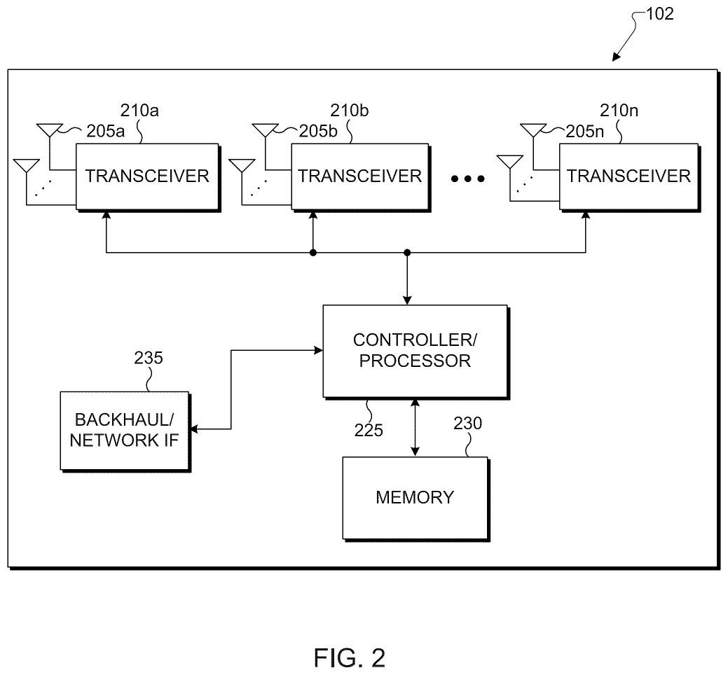

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for TBS determination in sidelink transmission. Any of a wide variety of other functions could be supported in the gNB 102 by the controller/processor 225.

The controller/processor 225 is also capable of executing programs and other processes resident in the memory 230, such as processes to support TBS determination in sidelink transmission. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

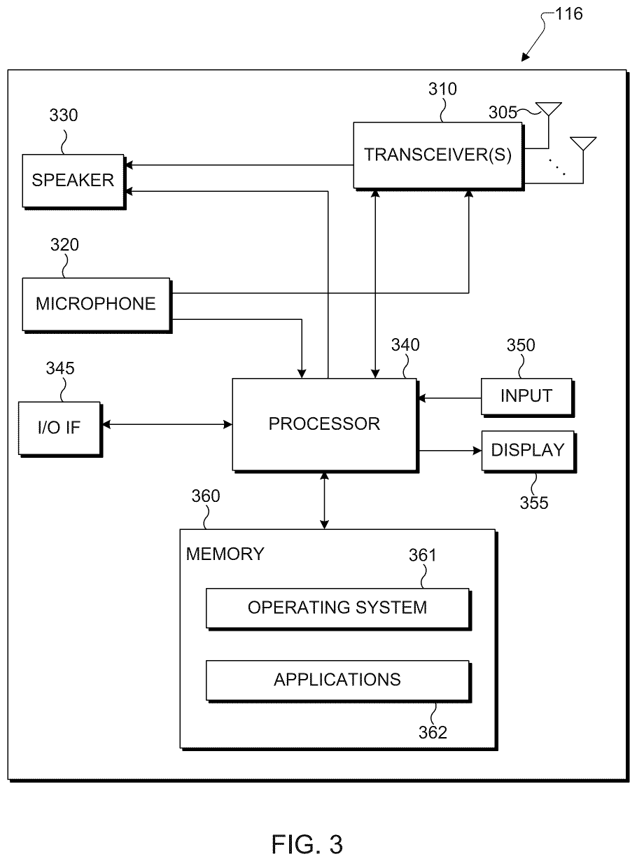

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL or SL channels or signals and the transmission of UL or SL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support TBS determination for sidelink transmission as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

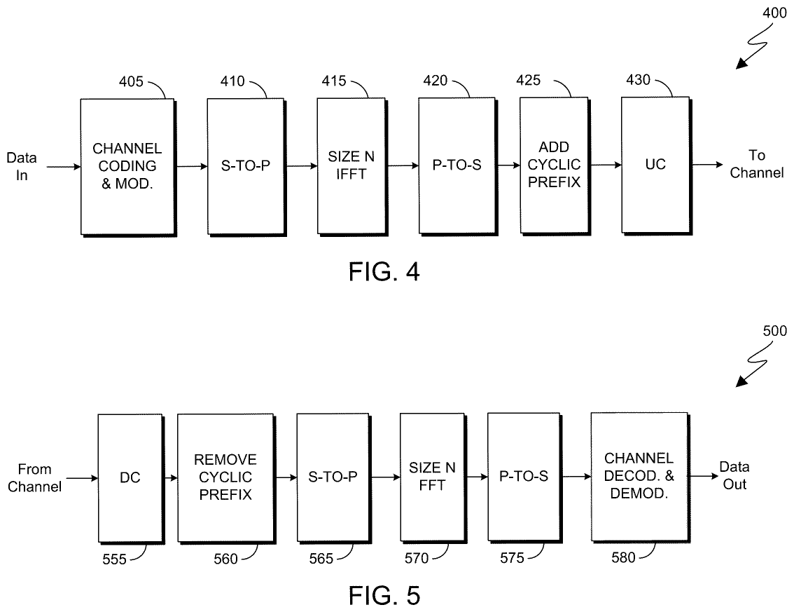

FIG. 4 and FIG. 5 illustrate example wireless transmit and receive paths 400 and 500 according to embodiments of the present disclosure. In the following description, a transmit path 400, of FIG. 4, may be described as being implemented in a gNB (such as the gNB 102) (or another UE), while a receive path 500, of FIG. 5, may be described as being implemented in a UE (such as a UE 116). However, it may be understood that the receive path 500 can be implemented in a gNB (or another UE) and that the transmit path 400 can be implemented in a UE. In some embodiments, the receive path 500 is configured to support TBS determination for sidelink transmission as described in embodiments of the present disclosure.

As shown in FIG. 4, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. As shown in FIG. 5, the receive path 500 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As further shown in FIG. 4, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

A transmitted RF signal from the gNB 102 arrives at the UE 116 after passing through the wireless channel, and reverse operations to those at the gNB 102 are performed at the UE 116. As further shown in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 that is analogous to transmitting in the downlink to UEs 111-116 and may implement a receive path 500 that is analogous to receiving in the uplink from UEs 111-116. Similarly, each of UEs 111-116 may implement a transmit path 400 for transmitting in the uplink to gNBs 101-103 (or in the SL for transmitting to another UE) and may implement a receive path 500 for receiving in the downlink from gNBs 101-103 (or in the SL for receiving from another UE).

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

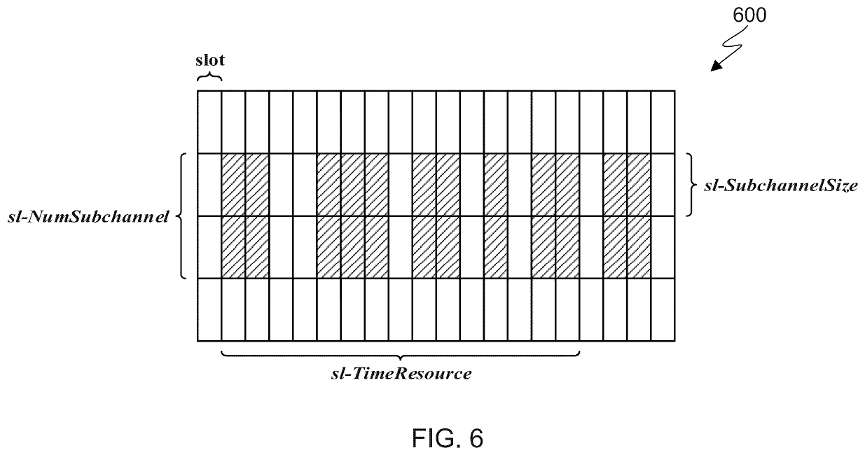

FIG. 6 illustrates a diagram 600 of a resource pool in Rel-16 NR V2X according to embodiments of the present disclosure. The embodiment of the diagram 600 illustrated in FIG. 6 is for illustration only. One or more components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the diagram 600.

As shown in FIG. 6, in Rel-16 NR V2X, transmission and reception of sidelink (SL) signals and channels are based on resource pool(s) confined in the configured SL bandwidth part (BWP). In the frequency domain, a resource pool consists of a (pre-)configured number (e.g., sl-NumSubchannel) of contiguous sub-channels, wherein each sub-channel consists of a set of contiguous resource blocks (RBs) in a slot with size (pre-)configured by higher layer parameter (e.g., sl-SubchannelSize). In the time domain, slots in a resource pool occur with a periodicity of 10240 ms, and slots including SL synchronization signal block (S-SSB), non-UL slots, and reserved slots are not applicable for a resource pool. The set of slots for a resource pool is further determined within the remaining slots, based on a (pre-)configured bitmap (e.g., sl-TimeResource).

Transmission and reception of physical sidelink shared channel (PSSCH), physical sidelink control channel (PSCCH), and physical sidelink feedback channel (PSFCH) are confined within and associated with a resource pool, with parameters (pre-)configured by higher layers (e.g., SL-PSSCH-Config, SL-PSCCH-Config, and SL-PSFCH-Config, respectively).

A UE (such as the UE 116) shall transmit the PSSCH in consecutive symbols within a slot of the resource pool, and PSSCH resource allocation starts from the second symbol configured for sidelink, e.g., startSLsymbol+1, and the first symbol configured for sidelink is duplicated from the second configured for sidelink, for automatic gain control (AGC) purpose. The UE shall not transmit PSSCH in symbols not configured for sidelink, or in symbols configured for PSFCH, or in the last symbol configured for sidelink, or in the symbol immediately preceding the PSFCH. The frequency domain resource allocation unit for PSSCH is the sub-channel, and the sub-channel assignment is determined using the corresponding field in the associated sidelink control information (SCI).

For transmitting a PSCCH, the UE can be provided a number of symbols (either 2 symbols or 3 symbols) in a resource pool (e.g., sl-TimeResourcePSCCH) starting from the second symbol configured for sidelink, e.g., startSLsymbol+1; and further provided a number of RBs in the resource pool (e.g., sl-FreqResourcePSCCH) starting from the lowest RB of the lowest sub-channel of the associated PSSCH.

The UE can be further provided a number of slots (e.g., sl-PSFCH-Period) in the resource pool for a period of PSFCH transmission occasion resources, and a slot in the resource pool is determined as containing a PSFCH transmission occasion if the relative slot index within the resource pool is an integer multiple of the period of PSFCH transmission occasion. PSFCH is transmitted in two contiguous symbols in a slot, wherein the second symbol is with index startSLsymbols+lengthSLsymbols−2, and the two symbols are repeated. In frequency domain, PSFCH is transmitted in a single RB, wherein orthogonal cover code (OCC) can be possibly applied within the RB for multiplexing, and the location of the RB is determined based on an indication of a bitmap (e.g., sl-PSFCH-RB-Set), and the selection of PSFCH resource is according to the source ID and destination ID.

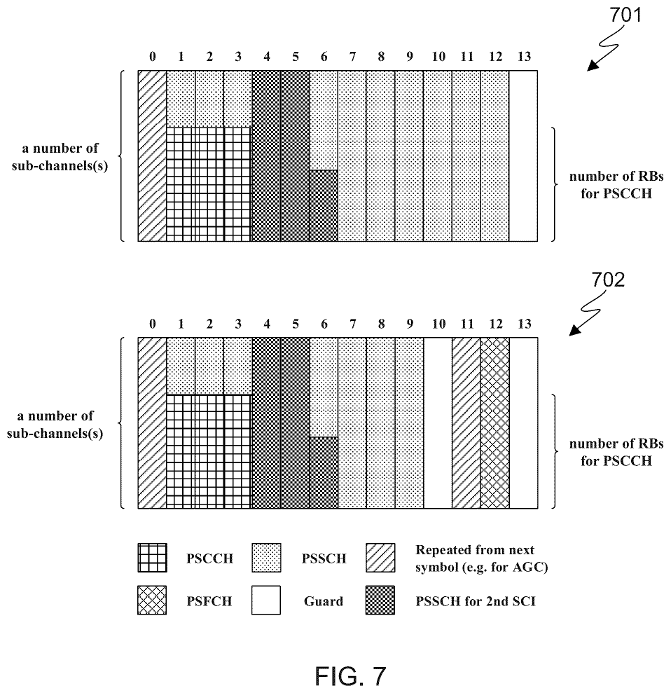

FIG. 7 illustrates diagrams 701 and 702 of slot structures for SL transmission and reception according to embodiments of the present disclosure. The embodiments of the diagrams 701 and 702 illustrated in FIG. 7 are for illustration only. One or more components illustrated in FIG. 7 can be implemented in specialized circuitry configured to perform the noted functions or one or more of the components can be implemented by one or more processors executing instructions to perform the noted functions. FIG. 7 does not limit the scope of this disclosure to any particular implementation of the diagrams 701 and 702.

As shown in FIG. 7, the first symbol of the diagrams 701 and 702, including PSSCH and PSCCH, is duplicated for AGC purpose. Further, the slot structure including PSSCH and PSCCH is shown in diagram 701 of FIG. 7, and the slot structure including PSSCH, PSCCH and PSFCH is shown in diagram 702 of FIG. 7.

For sidelink (SL) operating on unlicensed or shared spectrum, two types of channel access procedure can be supported, wherein one type of channel access procedure can be further classified into three sub-types.

In Type 1 SL channel access procedure, the time duration spanned by the sensing slots that are sensed to be idle before sidelink transmission(s) is random and based on a counter, wherein the channel access procedure is associated with a channel access priority class (e.g., p).

In Type 2 SL channel access procedure, the time duration spanned by the sensing slots that are sensed to be idle before sidelink transmission(s) is deterministic. In Type 2A SL channel access procedure, the time duration is deterministic as 25 μs. In Type 2B SL channel access procedure, the time duration is deterministic as 16 μs. In Type 2C SL channel access procedure, the time duration is deterministic as 0 μs.

For sidelink operating on unlicensed or shared spectrum, various embodiments of the present disclosure recognize a need to support flexible starting location in a slot for sidelink transmission, since the channel access procedure can succeed at any moment in the slot. Furthermore, to utilize the compatible channel access procedure, various embodiments of present disclosure recognize that adjustment to a symbol duration to generate a proper gap from a previous transmission is needed. This adjustment is typically performed over the first symbol and extending the cyclic prefix (CP) of that symbol to a longer duration.

Accordingly, the present disclosure includes embodiments for supporting flexible starting location for sidelink transmission, including how to determine the transport block size (TBS). In addition, the present disclosure covers detailed aspects on the utilization of CP extension on the SL transmissions.

The present disclosure provides a determination method for transport block size (TBS) for PSSCH transmission. As will be described in more detail below, the disclosure involves a time domain information for TBS determination component and a frequency domain information for TBS determination component.

The present disclosure also relates to the utilization of CP extension for sidelink transmission. As will be described in more detail below, the disclosure provides a first type of CP extension, a second type of CP extension, an application of the first type of CP extension, an application of the second type of CP extension, an application of no CP extension, and an example UE procedure.

In the present disclosure, a time domain information for TBS determination component is provided.

In one embodiment, when a UE determines the TBS for a PSSCH, the UE first determines the number of REs allocated for the PSSCH within a PRB (N_{RE}′), e.g., by N_{RE}′=N_{sc}^{RB}(N_{symb}^{sh}−N_{sumb}^{PSFCH})−Nₒₕ^{PRB}−N_{RE}^{DMRS}, where:
N_{sc}^{RB}=12 is the number of subcarriers in a physical resource block;
N_{symb}^{PSFCH}=3 if ‘PSFCH overhead indication’ field of SCI format 1-A indicates “1”, and N_{symb}^{PSFCH}=0 otherwise, if higher layer parameter sl-PSFCH-Period is 2 or 4. If higher layer parameter sl-PSFCH-Period is 0, N_{symb}^{PSECH}=0. If higher layer parameter sl-PSFCH-Period is 1, N_{symb}^{PSFCH}=3;
Nₒₕ^{PRB} is the overhead given by higher layer parameter sl-X-Overhead, and
N_{RE}^{DMRS} is determined according to higher layer parameter sl-PSSCH-DMRS-TimePatternList.

In one example, N_{symb}^{sh} can be determined based on the number of candidate starting symbols for PSSCH/PSCCH transmission in a slot, e.g., in a first manner when the number of candidate starting symbols for PSSCH/PSCCH transmission in a slot is 1, and in a second manner when the number of candidate starting symbols for PSSCH/PSCCH transmission in a slot is 2.

For one instance, the number of candidate starting symbols for PSSCH/PSCCH transmission can be provided by a (pre-)configuration, e.g., higher layer parameter.

For one sub-instance, there can be an explicit indication on either one or two candidate starting symbols for PSSCH/PSCCH transmission in a slot, e.g., by providing starting symbol index(es).

For another sub-instance, there can be an explicit indication on the symbol index of the first and/or second candidate starting symbol for PSSCH/PSCCH transmission in a slot, and the presence of such (pre-)configuration can be used for indicating two candidate starting symbols for PSSCH/PSCCH transmission in a slot, and the non-presence of such (pre-)configuration can be used for indicating one candidate starting symbols for PSSCH/PSCCH transmission in a slot.

For another instance, when there is one candidate starting symbol for PSSCH/PSCCH transmission in the slot, N_{symb}^{sh}=N₁.

For yet another instance, when there is two candidate starting symbols for PSSCH/PSCCH transmission in the slot, N_{symb}^{sh}=N₂.

For yet another instance, when there are two candidate starting symbols for PSSCH/PSCCH transmission in the slot, N_{symb}^{sh} can be determined as one from two candidate values: N_{symb}^{sh}=N₁ or N_{ymb}^{sh}=N₂.

For one sub-instance, N₁=I₁−2, where I₁ can be given by sl-LengthSymbols or a new parameter provided by higher layers, referring to the number of sidelink symbols within the slot.

For another sub-instance, N₁=I₁−3, where I₁ can be given by sl-LengthSymbols or a new parameter provided by higher layers, referring to the number of sidelink symbols within the slot. In this sub-instance, two AGC symbols and one gap symbol are assumed.

For yet another sub-instance, N₁=I₁−1−K, where I₁ can be given by sl-LengthSymbols or a new parameter provided by higher layers, referring to the number of sidelink symbols within the slot, and K is the number of symbols for AGC in the slot. For example, K can be fixed as 2 when there are two candidate starting symbols for PSSCH/PSCCH transmission in the slot; and/or K can be fixed as 1 when there are two candidate starting symbols for PSSCH/PSCCH transmission in the slot; and/or K can be indicated in the SCI.

For yet another sub-instance, N₁=I₁−L−K, where I₁ can be given by sl-LengthSymbols or a new parameter provided by higher layers, referring to the number of sidelink symbols within the slot, and K is the number of symbols for AGC in the slot, and L is the number of gap symbol in the slot. For example, K can be fixed as 2 when there are two candidate starting symbols for PSSCH/PSCCH transmission in the slot; and/or K can be fixed as 1 when there are two candidate starting symbols for PSSCH/PSCCH transmission in the slot; and/or K can be indicated in the SCI. For example, L can be fixed as 1; or L can be indicated in the SCI (e.g., to take value from either 1 or 0 based on an indication that whether the last symbol in the slot is used as gap symbol).

For yet another sub-instance, N₁=12−S₁, where S₁ is the first candidate starting symbol for PSSCH/PSCCH transmission in the slot.

For yet another sub-instance, N₁=11−S₁, where S₁ is the first candidate starting symbol for PSSCH/PSCCH transmission in the slot.

For yet another sub-instance, N₁ is associated with the first candidate starting symbol for PSSCH/PSCCH transmission in the slot.

For one sub-instance, N₂=I₂−2−(S₂−S₁), where I₂ can be given by sl-LengthSymbols or a new parameter provided by higher layers, referring to the number of sidelink symbols within the slot, S₁ is the first candidate starting symbol for PSSCH/PSCCH transmission in the slot, and S₂ is the second candidate starting symbol for PSSCH/PSCCH transmission in the slot.

For another sub-instance, N₂=I₂−1−L−(S₂−S₁), where I₂ can be given by sl-LengthSymbols or a new parameter provided by higher layers, referring to the number of sidelink symbols within the slot provided by higher layers, S₁ is the first candidate starting symbol for PSSCH/PSCCH transmission in the slot, and S₂ is the second candidate starting symbol for PSSCH/PSCCH transmission in the slot, and L is the number of gap symbol in the slot. For example, L can be fixed as 1; or L can be indicated in the SCI (e.g., to take value from either 1 or 0 based on an indication that whether the last symbol in the slot is used as gap symbol).

For yet another sub-instance, N₂=I₂−2, where I₂ can be given by sl-LengthSymbols or a new parameter provided by higher layers, referring to the number of sidelink symbols within the slot.

For yet another sub-instance, N₂=I₂−3, where I₂ can be given by sl-LengthSymbols or a new parameter provided by higher layers, referring to the number of sidelink symbols within the slot. In this sub-instance, two AGC symbols and one gap symbol are assumed. For yet another sub-instance, N₂=I₂−1−K, where I₂ can be given by sl-LengthSymbols or a new parameter provided by higher layers, referring to the number of sidelink symbols within the slot, and K is the number of symbols for AGC in the slot. For example, K can be fixed as 2 when there are two candidate starting symbols for PSSCH/PSCCH transmission in the slot; and/or K can be fixed as 1 when there are two candidate starting symbols for PSSCH/PSCCH transmission in the slot; and/or K can be indicated in the SCI.

For yet another sub-instance, N₂=12−S₂, where S₂ is the second candidate starting symbol for PSSCH/PSCCH transmission in the slot.

For yet another sub-instance, N₂ is associated with the second candidate starting symbol for PSSCH/PSCCH transmission in the slot.

For one sub-instance, there can be an indication in a SCI, and based on the indication, the UE can decide which of N₁ and N₂ should be used for TBS determination. For example, the indication can be for which starting symbol is used for PSSCH transmission, and the UE can decide from N₁ and N₂ accordingly.

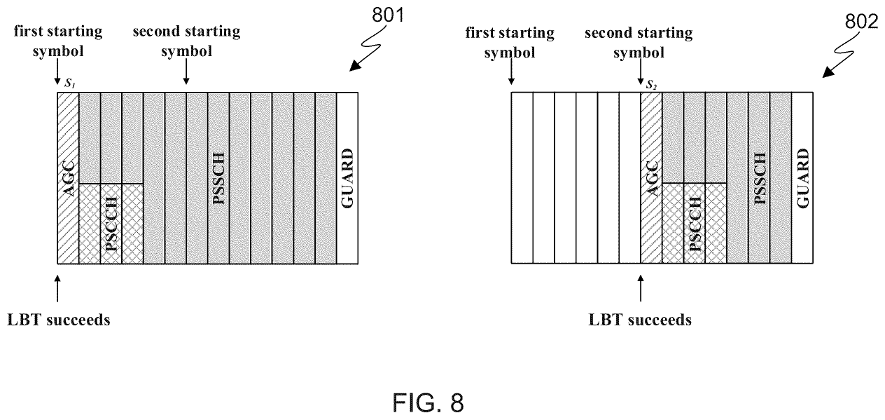

FIG. 8 illustrates diagrams 801 and 802 of PSCCHs and PSSCHs subject to a starting symbol according to embodiments of the present disclosure. The embodiments of the diagrams 801 and 802 illustrated in FIG. 8 are for illustration only. One or more components illustrated in FIG. 8 can be implemented in specialized circuitry configured to perform the noted functions or one or more of the components can be implemented by one or more processors executing instructions to perform the noted functions. FIG. 8 does not limit the scope of this disclosure to any particular implementation of the diagrams 801 and 802.

As shown in FIG. 8, for another sub-instance, the determination between N₁ and N₂ can be based on the location of the received PSCCH in the slot. For example, as shown in diagram 801 and 802, denoting the first candidate starting symbol in the slot as S₁ and the second candidate starting symbol in the slot as S₂, the starting symbol for PSSCH can be aligned with either the first or the second candidate starting symbol in the slot (e.g., subject to channel access procedure), wherein the first symbol is assumed for AGC purpose (e.g., not counted for TBS determination of PSSCH). Assume the starting symbol for PSCCH is associated with the first candidate starting symbol in the slot or the second candidate starting symbol in the slot, e.g., when PSSCH transmission starts from the first candidate starting symbol in the slot (S₁), the PSCCH transmission starts from symbol S₁+1, as illustrated in diagram 801; and when PSSCH transmission starts from the second candidate starting symbol in the slot (S₂), the PSCCH transmission starts from symbol S₂+1, as illustrated in diagram 802. When a UE receives the PSCCH, the UE can determine the starting symbol of the PSCCH, and further determines the associated starting symbol for the PSSCH, e.g., if denoting the starting symbol of the PSCCH as S_{PSCCH}, then the starting symbol of the PSSCH in the slot is given by S_{PSCCH}−1. The UE can further determine the N_{symb}^{sh} used for PSSCH TBS, such as, if S_{PSCCH}−1=S₁, N_{symb}^{sh}=N₁; if S_{PSCCH}−1=S₂, N_{symb}^{sh}=N₂, wherein the value of N₁ and N₂ can be subject to examples of this disclosure.

For yet another sub-instance, when a UE determines the transmission is within a shared channel occupancy from another UE, the UE can determine N_{symb}^{sh}=N₁ when determining the TBS.

For yet another sub-instance, when a UE determines the transmission is within a set of SL transmissions in a set of contiguous slots (e.g., not the first transmission in the set), the UE can determine N_{symb}^{sh}=N₁ when determining the TBS.

For one sub-instance, a UE assumes a default value N_{symb}^{sh}=N₁ when determining the TBS.

For another sub-instance, a UE assumes a default value N_{symb}^{sh}=N₂ when determining the TBS.

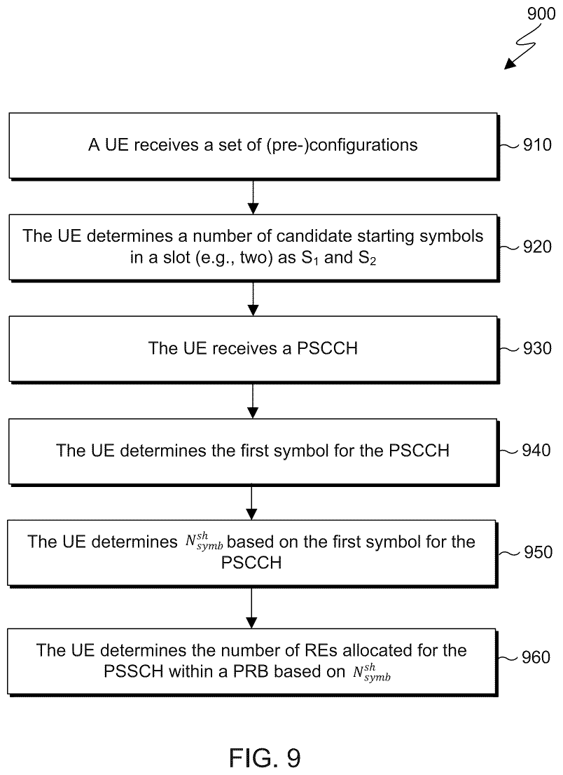

FIG. 9 illustrates a flowchart of a UE procedure 900 for determining the number of REs for PSSCH in a RB according to embodiments of the present disclosure. The UE procedure 900 may be performed by a UE (e.g., any of the UEs 111-116 as illustrated in FIG. 1). An embodiment of the UE procedure 900 shown in FIG. 9 is for illustration only and does not limit the scope of this disclosure to any particular implementation.

As shown in FIG. 9, the UE procedure 900 begins at step 910, where a UE (such as the UE 116) receives a set of (pre-)configurations. At step 920, the UE determines a number of candidate starting symbols in a slot (e.g., two) as S₁ and S₂. At step 930, the UE receives a PSCCH. At step 940, the UE determines the first symbol for the PSCCH. At step 950, the UE determines N_{symb}^{sh} based on the first symbol for the PSCCH. At step 960, the UE determines the number of REs allocated for the PSSCH within a PRB based on N_{symb}^{sh}.

In the present disclosure, a frequency domain information for TBS determination component is provided.

In one embodiment, when a UE determines the TBS for a PSSCH, the UE then determines the total number of REs allocated for the PSSCH by N_{RE}=N_{RE}′·n_{PRR}−N_{RE}^{SCI,1}−N_{RE}^{SCI,2}, where:
n_{PRB} is the total number of allocated PRBs for the PSSCH;
N_{RE}^{SCI,1} is the total number of REs occupied by the PSCCH and PSCCH DM-RS; and
N_{RE}^{SCI,2} is the number of coded modulation symbols generated for 2^{nd}-stage SCI transmission.

In one example, the UE can determine a set of RB-sets that include the PRBs allocated for the PSSCH.

For one instance, the set of RB-sets are contiguous in the frequency domain.

For another instance, the set of RB-sets can be indicated by the PSCCH that schedules the PSSCH transmission.

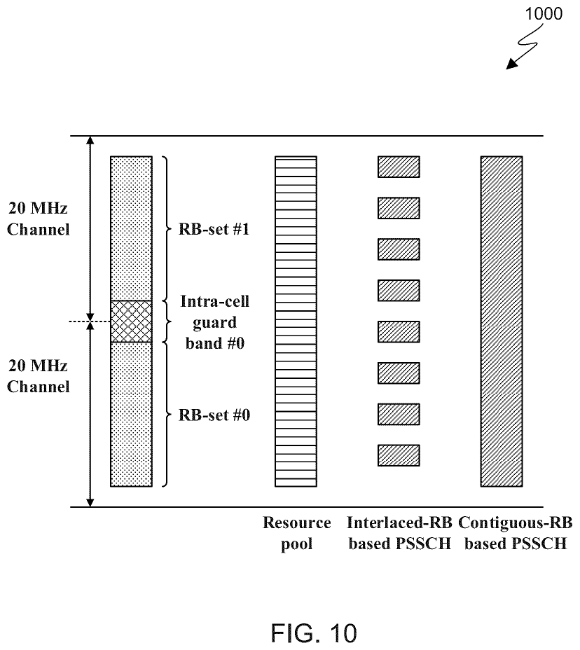

FIG. 10 illustrates a diagram 1000 of a PSSCH for wideband scenario according to embodiments of the present disclosure. The embodiment of the diagram 1000 illustrated in FIG. 10 is for illustration only. One or more components illustrated in FIG. 10 can be implemented in specialized circuitry configured to perform the noted functions or one or more of the components can be implemented by one or more processors executing instructions to perform the noted functions. FIG. 10 does not limit the scope of this disclosure to any particular implementation of the diagram 1000.

As shown in FIG. 10, in another example, for the interlaced-RB based PSSCH transmission, the UE can determine a set of interlaces that include the PRBs allocated for PSSCH.

For one instance, the set of interlaces are contiguous in the frequency domain.

For another instance, the set of interlaces can be indicated by the PSCCH that schedules the PSSCH transmission.

For yet another instance, the set of interlaces can be determined based on a set of sub-channels, wherein one sub-channel includes one or multiple interlaces.

For yet another instance, the set of sub-channels are contiguous in the frequency domain.

For yet another instance, the set of sub-channels can be indicated by the PSCCH that schedules the PSSCH transmission.

In yet another example, for the interlaced-RB based PSSCH transmission, the UE can determine a set of PRBs as the intersection between the set of RB-sets together with the intra-cell guard band in between neighbouring RB-sets and the set of interlaces, and n_{PRB} is the number of PRBs in the set of PRBs.

For instance, n_{PRB}=Σₛ₌₀^{N}^{_{RB-set}}⁻¹ Σᵢ₌₀^{N}^{ᵢₙₜ}⁻¹ N_{RB}^{s,i}+Σⱼ₌₀^{N}^{_{RB-set}}⁻² Σᵢ₌₀^{N}^{ᵢₙₜ}⁻¹ M_{RB}^{j,i}, wherein N_{RB-set} is the number of RB-sets in the set of RB-sets (e.g., the set of RB-sets are the ones that include the PRBs allocated for the PSSCH, as described in the disclosure), Nᵢₙₜ is the number of interlaces in the set of interlaces, N_{RB}^{s,i} is the number of PRBs in the intersection between RB-set #s and interlace #i, and M_{RB}^{j,i} is the number of PRBs in the intersection between intra-cell guard band #j and interlace #i.
For one sub-instance, N_{RB}^{s,i} can be given by a fixed number, e.g., 10 or 11, which is common for RB-sets and interlaces. Then, Σₛ₌₀^{N}^{_{RB-set}}⁻¹ Σᵢ₌₀^{N}^{ᵢₙₜ}⁻¹ N_{RB}^{s,i}=N_{RB-set}·Nᵢₙₜ·N_{RB}^{s,i}.
For another sub-instance, N_{SB}^{s,i} can be provided by a (pre-)configuration, which is common for RB-sets and interlaces, e.g., with candidate values from 10 or 11. Then, Σₛ₌₀^{N}^{_{RB-set}}⁻¹ Σᵢ₌₀^{N}^{ᵢₙₜ}⁻¹ N_{RB}^{s,i}=N_{RB-set}·Nᵢₙₜ·N_{RB}^{s,i}.
For yet another sub-instance, M_{RB}^{j,i} can be given by a fixed number, e.g., 0, then Σⱼ₌₀^{N}^{_{RB-set}}⁻² Σᵢ₌₀^{R}^{ᵢₙₜ}⁻¹ M_{RB}^{j,i}=0, which implies the RBs in the intra-cell guard band(s) are not counted.
For yet another sub-instance, M_{RB}^{j,i} can be given by a fixed number, e.g., 1, then Σⱼ₌₀^{N}^{_{RB-set}}⁻² Σᵢ₌₀^{N}^{ᵢₙₜ}⁻¹ M_{RB}^{j,i}=(N_{RB-set}−1)·Nᵢₙₜ.
For yet another sub-instance, M_{RB}^{j,i} can be provided by a (pre-)configuration, which is common for RB-sets and interlaces, then Σⱼ₌₀^{N}^{_{RB-set}}⁻² Σᵢ₌₀^{N}^{ᵢₙₜ}⁻¹ M_{RB}^{j,i}=(N_{RB-set}−1)·Nᵢₙₜ·M_{RB}^{j,i}.
For yet another sub-instance, Nᵢₙₜ=N_{sub-channel}·Nᵢₙₜ^{sub-channel}, wherein N_{sub-channel} is a number of sub-channels allocated for the PSSCH within a RB-set (e.g., scheduled, or configured, or selected), and Nᵢₙₜ^{sub-channel} is a number of interlaces in a sub-channel (e.g., the sub-channel can be confined in a RB-set as described in the disclosure). For one sub-instance, N_{sub-channel} can be determined based on the indication by the SCI. For another sub-instance, N_{sub-channel} can be (pre-)configured. For yet another sub-instance, Nᵢₙₜ^{sub-channel} can be (pre-)configured.
For yet another sub-instance, Nᵢₙₜ can be (pre-)configured.
For yet another sub-instance, N_{RB-set} can be determined based on the indication by the SCI.
For yet another sub-instance, N_{RB-set} can be fixed, e.g., fixed as 1.
For yet another sub-instance, N_{RB-set} can be (pre-)configured.

As also shown in FIG. 10, in yet another example, for the contiguous-RB based PSSCH transmission, the UE can determine a set of sub-channels (e.g., a number of N_{sub-channel} sub-channels) that include the PRBs allocated for PSSCH, wherein each sub-channel include a number of contiguous PRBs (N_{RB}). Then, the total number of PRBs allocated for PSSCH n_{PRB}=N_{sub-channel}·N_{RB}.

For one instance, the set of sub-channels are contiguous in the frequency domain.

For another instance, the set of sub-channels can be indicated by the PSCCH that schedules the PSSCH transmission.

For yet another instance, if the set of sub-channels overlap with at least two RB-sets, the set of sub-channels include the PRBs that allocate in the intra-cell guard(s) in between every neighbouring RB-sets in the at least two RB-sets.

In yet another example, for the contiguous-RB based PSSCH transmission, the UE can determine a set of PRBs in the set of sub-channels, and n_{PRB} is the number of PRBs in the set of PRBs.

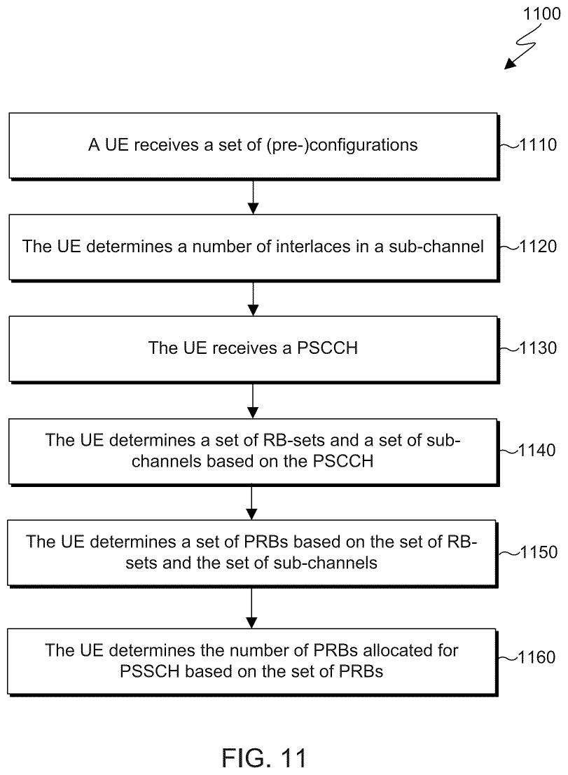

FIG. 11 illustrates a flowchart of a UE procedure 1100 for determining the number of PRBs for PSSCH according to embodiments of the present disclosure. The UE procedure 1100 may be performed by a UE (e.g., any of the UEs 111-116 as illustrated in FIG. 1). An embodiment of the UE procedure 1100 shown in FIG. 11 is for illustration only and does not limit the scope of this disclosure to any particular implementation.

As shown in FIG. 11, the UE procedure 1100 begins at step 1110, where a UE (such as the UE 116) receives a set of (pre-)configurations. At step 1120, the UE determines a number of interlaces in a sub-channel. At step 1130, the UE receives a PSCCH. At step 1140, the UE determines a set of RB-sets and a set of sub-channels based on the PSCCH. At step 1150, the UE determines a set of PRBs based on the set of RB-sets and the set of sub-channels. At step 1160, the UE determines the number of PRBs allocated for PSSCH based on the set of PRBs.

In the present disclosure, a first type of CP extension is provided.

In one embodiment, a first type of CP extension can be supported, wherein the maximum length of CP extension is no larger than an OFDM symbol with SCS corresponding to the OFDM symbol being applied with the CP extension.

In one example, the duration of the CP extension of a sidelink OFDM symbol Tₑₓₜ (e.g., for normal CP length) can be given by:

$$\\ {T}_{ext} = min ( max ( {T}_{ext}^{{}_{} ′} , 0 ) , {T}_{sym b , ( l - 1 ) mod 7 \cdot {2}^{{}_{} μ}}^{{}_{} μ} ) , wherein$$

$$\\ {T}_{ext}^{{}_{} ′} = {\sum }_{k = 1}^{{C}_{i}} {T}_{sym b , ( l - k ) mod 7 \cdot {2}^{{}_{} μ}}^{{}_{} μ} - {Δ}_{i} .$$

In another example, the duration of the CP extension of a sidelink OFDM symbol Tₑₓₜ (e.g., for normal CP length) can be given by:

$$\\ {T}_{ext} = {\sum }_{k = 1}^{{C}_{i}} {T}_{sym b , ( l - k ) mod 7 \cdot {2}^{{}_{} μ}}^{{}_{} μ} - {Δ}_{i} .$$

In yet another example, the duration of the CP extension of a sidelink OFDM symbol Tₑₓₜ (e.g., for extended CP length) can be given by:

$$\\ {T}_{ext} = min ( max ( {T}_{ext}^{{}_{} ′} , 0 ) , {T}_{sym b , ( l - 1 ) mod 6 \cdot {2}^{{}_{} μ}}^{{}_{} μ} ) , wherein$$

$$\\ {T}_{ext}^{{}_{} ′} = {\sum }_{k = 1}^{{C}_{i}} {T}_{sym b , ( l - k ) mod 6 \cdot {2}^{{}_{} μ}}^{{}_{} μ} - {Δ}_{i} .$$

In yet another example, the duration of the CP extension of a sidelink OFDM symbol Tₑₓₜ (e.g., for extended CP length) can be given by:

$$\\ {T}_{ext} = {\sum }_{k = 1}^{{C}_{i}} {T}_{sym b , ( l - k ) mod 6 \cdot {2}^{{}_{} μ}}^{{}_{} μ} - {Δ}_{i} .$$

In one example, Δᵢ can be given by Table 1 with a corresponding index i, wherein how i is provided to the UE can be according to an example in the disclosure (Cᵢ and Δᵢ not provided with index 0 refer to Tₑₓₜ=0, e.g., no CP extension). Table 1 provides example parameters for CP extension.

TABLE 1

| i | Cᵢ | Δᵢ |
|---|---|---|
| 0 | — | — |
| 1 | C₁ | 25 · 10⁻⁶ |

In another example, Δᵢ can be given by Table 2 with a corresponding index i, wherein how i is provided to the UE can be according to an example in the disclosure (Cᵢ and Δᵢ not provided with index 0 refer to Tₑₓₜ=0, e.g., no CP extension). Table 2 provides example parameters for CP extension.

TABLE 2

| i | Cᵢ | Δᵢ |
|---|---|---|
| 0 | — | — |
| 1 | C₁ | 25 · 10⁻⁶ |
| 2 | C₂ | 16 · 10⁻⁶ |

In yet another example, Δᵢ can be given by Table 3 with a corresponding index i, wherein how i is provided to the UE can be according to an example in the disclosure (Cᵢ and Δᵢ not provided with index 0 refer to Tₑₓₜ=0, e.g., no CP extension). Table 3 provides example parameters for CP extension.

TABLE 3

| i | Cᵢ | Δᵢ |
|---|---|---|
| 0 | — | — |
| 1 | C₁ | 25 · 10⁻⁶ |
| 2 | C₂ | 16 · 10⁻⁶ |
| 3 | C₃ | 0 |

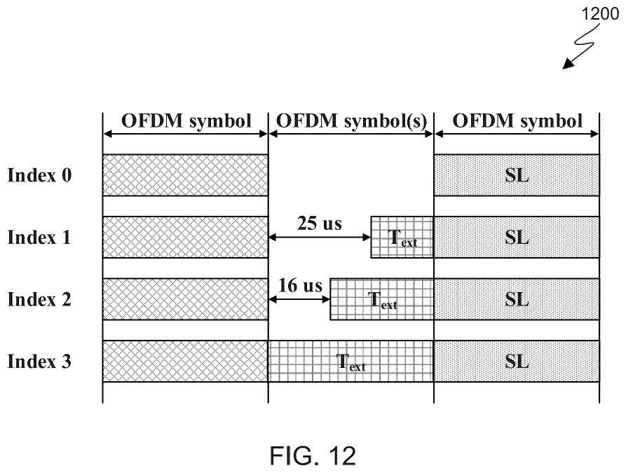

FIG. 12 illustrates a diagram 1200 of example cases for the first type of CP extension according to embodiments of the present disclosure. The embodiment of the diagram 1200 illustrated in FIG. 12 is for illustration only. One or more components illustrated in FIG. 12 can be implemented in specialized circuitry configured to perform the noted functions or one or more of the components can be implemented by one or more processors executing instructions to perform the noted functions. FIG. 12 does not limit the scope of this disclosure to any particular implementation of the diagram 1200.

In one example, for normal CP, C₁=1 for μ=0.

In another example, for normal CP, C₁=1 for μ=1.

In yet another example, for normal CP, C₁=2 for μ=2.

In yet another example, for extended CP, C₁=2 for μ=2.

In one example, for normal CP, C₂=1 for μ=0.

In another example, for normal CP, C₂=1 for μ=1.

In yet another example, for normal CP, C₂=1 for μ=2.

In yet another example, for extended CP, C₂=1 for μ=2.

In one example, for normal CP, C₃=1 for μ=0.

In another example, for normal CP, C₃=1 for μ=1.

In yet another example, for normal CP, C₃=1 for μ=2.

In yet another example, for extended CP, C₃=1 for μ=2.

In the present disclosure, a second type of CP extension is provided.

In one embodiment, a second type of CP extension can be supported, wherein the maximum length of CP extension is no larger than a duration based on a reference SCS.

In one example, the duration of the CP extension of a sidelink OFDM symbol Tₑₓₜ (e.g., for normal CP length) can be given by:

$$\\ {T}_{ext} = {\sum }_{k = 1}^{C} {T}_{sym b , ( l - k ) mod 7 \cdot {2}^{{}_{} μ}}^{{}_{} μ} - {Δ}_{i} .$$

In another example, the duration of the CP extension of a sidelink OFDM symbol Tₑₓₜ (e.g., for normal CP length) can be given by:

$$\\ {T}_{ext} = max ( {\sum }_{k = 1}^{C} {T}_{sym b , ( l - k ) mod 7 \cdot {2}^{{}_{} μ}}^{{}_{} μ} - {Δ}_{i} , 0 ) .$$

In yet another example, the duration of the CP extension of a sidelink OFDM symbol Tₑₓₜ (e.g., for extended CP length) can be given by:

$$\\ {T}_{ext} = {\sum }_{k = 1}^{C} {T}_{sym b , ( l - k ) mod 6 \cdot {2}^{{}_{} μ}}^{{}_{} μ} - {Δ}_{i} .$$

In yet another example, the duration of the CP extension of a sidelink OFDM symbol Tₑₓₜ (e.g., for extended CP length) can be given by:

$$\\ {T}_{ext} = max ( {\sum }_{k = 1}^{C} {T}_{sym b , ( l - k ) mod 6 \cdot {2}^{{}_{} μ}}^{{}_{} μ} - {Δ}_{i} , 0 ) .$$

In one example, for normal CP, C=1 for μ=0.

In another example, for normal CP, C=2 for μ=1.

In yet another example, for normal CP, C=2 for μ=2.

In yet another example, for extended CP, C=2 for μ=2.

In yet another example, C can be provided by a (pre-)configuration or indication. For instance, C∈{1} for μ=0, and C∈{1, 2} for μ=1, 2 (e.g., C can take one or multiple values from {1, 2} based on the (pre-)configuration or indication, which can be jointly or separately with the (pre-)configuration or indication for Δᵢ).

In one example, Δᵢ can be given by Table 4 (e.g., for normal CP) with a corresponding index i, wherein how i is provided to the UE can be according to an example in the disclosure (e.g., index 6 refers to Tₑₓₜ=0). Table 4 provides example parameters for CP extension with normal CP. In one further consideration, the value of C and Δᵢ shall be selected such that the value of Tₑₓₜ is not negative.

TABLE 4

| i | Δᵢ |
|---|---|
| 0 | 16 · 10⁻⁶ |
| 1 | 25 · 10⁻⁶ |
| 2 | 34 · 10⁻⁶ |
| 3 | 43 · 10⁻⁶ |
| 4 | 52 · 10⁻⁶ |
| 5 | 61 · 10⁻⁶ |
| 6 | Σₖ₌₁^{C} T_{symb, (l-k)mod 7·2}_{^{μ}}^{μ} |

In another example, Δᵢ can be given by Table 5 (e.g., for normal CP) with a corresponding index i, wherein how i is provided to the UE can be according to an example in the disclosure (e.g., index 6 refers to Tₑₓₜ=0). Table 5 provides example parameters for CP extension with normal CP. In one further consideration, the value of C and Δᵢ shall be selected such that the value of Tₑₓₜ is not negative.

TABLE 5

| i | Δᵢ |
|---|---|
| 0 | 16 · 10⁻⁶ |
| 1 | 25 · 10⁻⁶ |
| 2 | 34 · 10⁻⁶ |
| 3 | 43 · 10⁻⁶ |
| 4 | 52 · 10⁻⁶ |
| 5 | 61 · 10⁻⁶ |
| 6 | Σₖ₌₁^{C} T_{symb, (l-k)mod 7·2}_{^{μ}}^{μ} |
| 7 | 0 |

In yet another example, Δᵢ can be given by Table 6 (e.g., for extended CP) with a corresponding index i, wherein how i is provided to the UE can be according to an example in the disclosure (e.g., index 6 refers to Tₑₓₜ=0). Table 6 provides example parameters for CP extension with extended CP. In one further consideration, the value of C and Δᵢ shall be selected such that the value of Tₑₓₜ is not negative.

TABLE 6

| i | Δᵢ |
|---|---|
| 0 | 16 · 10⁻⁶ |
| 1 | 25 · 10⁻⁶ |
| 2 | 34 · 10⁻⁶ |
| 3 | 43 · 10⁻⁶ |
| 4 | 52 · 10⁻⁶ |
| 5 | 61 · 10⁻⁶ |
| 6 | Σₖ₌₁^{C} T_{symb, (l-k)mod 6·2}_{^{μ}}^{μ} |

In another example, Δᵢ can be given by Table 7 (e.g., for extended CP) with a corresponding index i, wherein how i is provided to the UE can be according to an example in the disclosure (e.g., index 6 refers to Tₑₓₜ=0). Table 7 provides example parameters for CP extension with extended CP. In one further consideration, the value of C and Δᵢ shall be selected such that the value of Tₑₓₜ is not negative.

TABLE 7

| i | Δᵢ |
|---|---|
| 0 | 16 · 10⁻⁶ |
| 1 | 25 · 10⁻⁶ |
| 2 | 34 · 10⁻⁶ |
| 3 | 43 · 10⁻⁶ |
| 4 | 52 · 10⁻⁶ |
| 5 | 61 · 10⁻⁶ |
| 6 | Σₖ₌₁^{C} T_{symb, (l-k)mod 6·2}_{^{μ}}^{μ} |
| 7 | 0 |

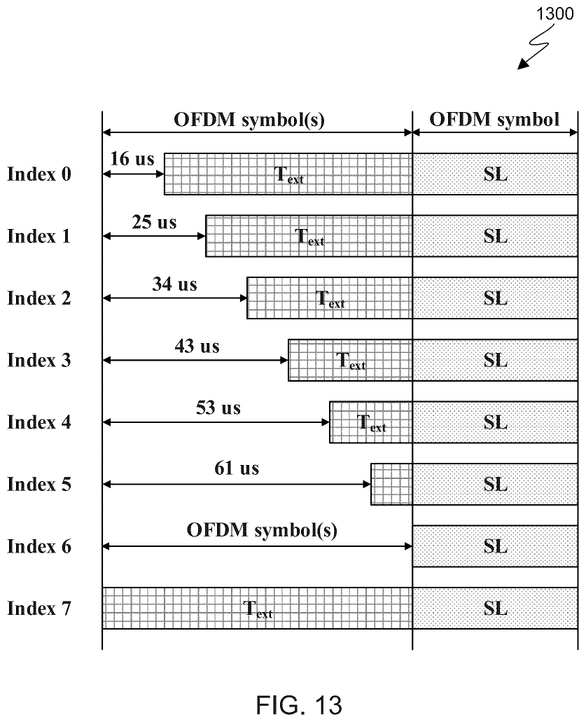

FIG. 13 illustrates a diagram 1300 of example cases for the second type of CP extension according to embodiments of the present disclosure. The embodiment of the diagram 1300 illustrated in FIG. 13 is for illustration only. One or more components illustrated in FIG. 13 can be implemented in specialized circuitry configured to perform the noted functions or one or more of the components can be implemented by one or more processors executing instructions to perform the noted functions. FIG. 13 does not limit the scope of this disclosure to any particular implementation of the diagram 1300.

In the present disclosure, an application of the CP extension is provided.

In one embodiment, there can be an indication on the first type or second type of CP extension. For one example, the indication can include at least one index for the first type and/or at least one index for the second type of CP extension. For another example, this can be applicable when there is guarantee that no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-) configuration. For one sub-instance, this example is applicable when the (pre-)configuration is provided.

For one example, the indication can be included in a SCI format.

In another example, the indication can be included in a DCI format.

In yet another example, the indication can be included in a MAC CE.

In yet another example, the indication can be included in a (pre-)configuration.

In yet another example, the indication can be included in a PC5 RRC parameter.

In another embodiment, for a SL transmission, if a UE is provided with an index for a first type or a second type of CP extension, the UE applies the corresponding CP extension regardless of other assumption on the CP extension (e.g., based on a (pre-)configuration).

In yet another embodiment, for a SL transmission, if a UE is provided with multiple indications on the index for a first type or a second type of CP extension, the UE assumes the indications correspond to the same CP extension.

In the present disclosure, an application of the first type of CP extension is provided.

In one embodiment, an index for the first type of CP extension can be included in a SCI format.

For one example, the SCI format can include channel occupancy information, wherein the channel occupancy information includes the index for the first type of CP extension.

For another example, the SCI format can also include channel occupancy information, wherein the channel occupancy information is associated with the index for the first type of CP extension.

For one example, when a UE receives the SCI format, and determines the UE is a responding UE to share the channel occupancy, the UE can apply a CP extension value to a first symbol of a next SL transmission (e.g., any SL transmission) based on the index of the first type of CP extension.

For another example, when a UE receives the SCI format, and determines the UE is a responding UE to share the channel occupancy, the UE can apply a CP extension value to a first symbol of a PSSCH/PSCCH transmission based on the index of the first type of CP extension.

For yet another example, when a UE receives the SCI format, and determines the UE is a responding UE to share the channel occupancy, the UE can apply a CP extension value to a first symbol of a PSFCH transmission based on the index of the first type of CP extension.

For yet another example, when a UE receives the SCI format, and determines the UE is a responding UE to share the channel occupancy, the UE can apply a CP extension value to a first symbol of a S-SS/PSBCH block transmission based on the index of the first type of CP extension.

In another embodiment, the first type of CP extension can be applied to a SL transmission as a first transmission in a channel occupancy initiated by the UE.

For one example, an index for the first type of CP extension can be fixed in the specification. For one instance, CP extension corresponding to i=0 is applied to the SL transmission. For another instance, CP extension corresponding to i=1 is applied to the SL transmission. For yet another instance, CP extension corresponding to i=2 is applied to the SL transmission. For yet another instance, CP extension corresponding to i=3 is applied to the SL transmission.

For another example, an index for the first type of CP extension can be provided by a (pre-)configuration.
For one sub-example, this can be applicable when the SL transmission does not occupy all RBs in a RB-set.
   For yet another sub-example, this can be applicable when the UE receives reservation information. For instance, the reservation information indicates another UE reserves/selects resources (e.g., an interlace or at least one RB) in the RB-set for its SL transmission, wherein the RB-set if used by the UE for SL transmission. For another instance, the reservation information indicates another UE reserves/selects resources (e.g., an interlace or at least one RB) in the sub-channel for its SL transmission, wherein the sub-channel is used by the UE for SL transmission. For yet another instance, the reservation information indicates another UE reserves/selects resources (e.g., an interlace or at least one RB) in the resource pool for its SL transmission, wherein the resource pool is used by the UE for SL transmission. For yet another instance, the reservation information indicates another UE reserves/selects resources (e.g., an interlace or at least one RB) in the BWP for its SL transmission, wherein the BWP is used by the UE for SL transmission.
   For yet another sub-example, this can be applicable when the UE does not transit reservation information to another UE. For instance, the reservation information indicates the sub-channel in the RB-set is used by the UE for SL transmission.
   For yet another sub-example, this can be applicable when there is no guarantee that no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-)configuration. For one sub-instance, this example is applicable when the (pre-)configuration is not provided.
For another sub-example, this can be applicable when the SL transmission occupies all the RBs in a RB-set.
For yet another sub-example, the (pre-)configuration can be a separate (pre-)configuration from a (pre-)configuration of the index for the first type of CP extension applied to SL transmission within a channel occupancy.

For yet another example, at least one index for the first type of CP extension can be provided by a (pre-)configuration. For one sub-example, the UE can randomly select one index and apply the corresponding CP extension to the SL transmission. For another sub-example, the UE can select one index based on the highest SL priority of the SL transmissions and apply the corresponding CP extension to the SL transmission (e.g., the UE can select the longest CP extension that the highest SL priority of the SL transmissions can correspond to).
For one sub-example, this can be applicable when the SL transmission occupies all the RBs in a RB-set.
For another sub-example, this can be applicable when the SL transmission does not occupy all RBs in a RB-set.
   For yet another sub-example, this can be applicable when the UE doesn't receive any reservation information. For instance, the reservation information indicates another UE reserves/selects resources (e.g., an interlace or at least one RB) in the RB-set for its SL transmission, wherein the RB-set if used by the UE for SL transmission. For another instance, the reservation information indicates another UE reserves/selects resources (e.g., an interlace or at least one RB) in the sub-channel for its SL transmission, wherein the sub-channel is used by the UE for SL transmission. For yet another instance, the reservation information indicates another UE reserves/selects resources (e.g., an interlace or at least one RB) in the resource pool for its SL transmission, wherein the resource pool is used by the UE for SL transmission. For yet another instance, the reservation information indicates another UE reserves/selects resources (e.g., an interlace or at least one RB) in the BWP for its SL transmission, wherein the BWP is used by the UE for SL transmission.
   For yet another sub-example, this can be applicable when the UE transits reservation information to another UE. For instance, the reservation information indicates the sub-channel in the RB-set is used by the UE for SL transmission.
   For yet another sub-example, this can be applicable when no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-)configuration. For one sub-instance, this example is applicable when the (pre-)configuration is provided.
For another sub-example, the (pre-)configuration can be a separate (pre-)configuration from a (pre-)configuration of the index for the first type of CP extension applied to SL transmission within a channel occupancy.
For yet another sub-example, the SL transmission can be PSSCH/PSCCH transmission.
For yet another sub-example, the SL transmission can be S-SS/PSBCH block transmission.

For yet another example, at least one index for the first type of CP extension can be provided by a (pre-)configuration. For another sub-example, the UE can select one index based on the highest SL priority of the SL transmissions and apply the corresponding CP extension to the SL transmission (e.g., the UE can select the longest CP extension that the highest SL priority of the SL transmissions can correspond to).
For one sub-example, this can be applicable when the SL transmission occupies all the RBs in a RB-set.
For another sub-example, this can be applicable when the SL transmission does not occupy all RBs in a RB-set.
   For yet another sub-example, this can be applicable when the UE doesn't receive any reservation information. For instance, the reservation information indicates another UE reserves/selects resources (e.g., an interlace or at least one RB) in the RB-set for its SL transmission, wherein the RB-set if used by the UE for SL transmission. For another instance, the reservation information indicates another UE reserves/selects resources (e.g., an interlace or at least one RB) in the sub-channel for its SL transmission, wherein the sub-channel is used by the UE for SL transmission. For yet another instance, the reservation information indicates another UE reserves/selects resources (e.g., an interlace or at least one RB) in the resource pool for its SL transmission, wherein the resource pool is used by the UE for SL transmission. For yet another instance, the reservation information indicates another UE reserves/selects resources (e.g., an interlace or at least one RB) in the BWP for its SL transmission, wherein the BWP is used by the UE for SL transmission.
   For yet another sub-example, this can be applicable when the UE transits reservation information to another UE. For instance, the reservation information indicates the sub-channel in the RB-set is used by the UE for SL transmission.
   For yet another sub-example, this can be applicable when no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-)configuration. For one sub-instance, this example is applicable when the (pre-)configuration is provided.
For another sub-example, the (pre-)configuration can be a separate (pre-)configuration from a (pre-)configuration of the index for the first type of CP extension applied to SL transmission within a channel occupancy.
For yet another sub-example, the SL transmission can be PSSCH/PSCCH transmission.
For yet another sub-example, the SL transmission can be S-SS/PSBCH block transmission.

For yet another example, if the (pre-)configuration is not provided, the UE can assume a default index for the first type of CP extension. For one instance, the default CP extension corresponding to i=0 is applied to the SL transmission. For another instance, the default CP extension corresponding to i=1 is applied to the SL transmission. For yet another instance, the default CP extension corresponding to i=2 is applied to the SL transmission. For yet another instance, the default CP extension corresponding to i=3 is applied to the SL transmission.

In yet another embodiment, the first type of CP extension can be applied to a SL transmission in a channel occupancy, e.g., shared by another UE, wherein the SL transmission is not the first SL transmission in the channel occupancy.

For one example, an index for the first type of CP extension can be fixed in the specification. For one instance, CP extension corresponding to i=3 is applied to the SL transmission. For another instance, CP extension corresponding to i=2 is applied to the SL transmission. For yet another instance, CP extension corresponding to i=1 is applied to the SL transmission. For yet another instance, CP extension corresponding to i=0 is applied to the SL transmission.

For another example, an index for the first type of CP extension can be provided by a (pre-)configuration.
For one sub-example, this can be applicable when the SL transmission does not occupy all RBs in a RB-set.
   For yet another sub-example, this can be applicable when the UE receives reservation information. For instance, the reservation information indicates another UE reserves/selects resources (e.g., an interlace or at least one RB) in the RB-set for its SL transmission, wherein the RB-set if used by the UE for SL transmission. For another instance, the reservation information indicates another UE reserves/selects resources (e.g., an interlace or at least one RB) in the sub-channel for its SL transmission, wherein the sub-channel is used by the UE for SL transmission. For yet another instance, the reservation information indicates another UE reserves/selects resources (e.g., an interlace or at least one RB) in the resource pool for its SL transmission, wherein the resource pool is used by the UE for SL transmission. For yet another instance, the reservation information indicates another UE reserves/selects resources (e.g., an interlace or at least one RB) in the BWP for its SL transmission, wherein the BWP is used by the UE for SL transmission.
   For yet another sub-example, this can be applicable when the UE does not transit reservation information to another UE. For instance, the reservation information indicates the sub-channel in the RB-set is used by the UE for SL transmission.
   For yet another sub-example, this can be applicable when there is no guarantee that no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-)configuration. For one sub-instance, this example is applicable when the (pre-)configuration is not provided.
For another sub-example, this can be applicable when the SL transmission occupies all the RBs in a RB-set.
For yet another sub-example, the (pre-)configuration can be a separate (pre-)configuration from a (pre-)configuration of the index for the first type of CP extension applied to SL transmission as a first transmission of a channel occupancy (e.g., not in a shared channel occupancy).

For yet another example, at least one index for the first type of CP extension can be provided by a (pre-)configuration. For one sub-example, the UE can randomly select one index and apply the corresponding CP extension to the SL transmission. For another sub-example, the UE can select one index based on the highest SL priority of the SL transmissions and apply the corresponding CP extension to the SL transmission (e.g., the UE can select the longest CP extension that the highest SL priority of the SL transmissions can correspond to).
For one sub-example, this can be applicable when the SL transmission occupies all the RBs in a RB-set.
For another sub-example, this can be applicable when the SL transmission does not occupy all RBs in a RB-set.
   For yet another sub-example, this can be applicable when the UE doesn't receive any reservation information. For instance, the reservation information indicates another UE reserves/selects resources (e.g., an interlace or at least one RB) in the RB-set for its SL transmission, wherein the RB-set if used by the UE for SL transmission. For another instance, the reservation information indicates another UE reserves/selects resources (e.g., an interlace or at least one RB) in the sub-channel for its SL transmission, wherein the sub-channel is used by the UE for SL transmission. For yet another instance, the reservation information indicates another UE reserves/selects resources (e.g., an interlace or at least one RB) in the resource pool for its SL transmission, wherein the resource pool is used by the UE for SL transmission. For yet another instance, the reservation information indicates another UE reserves/selects resources (e.g., an interlace or at least one RB) in the BWP for its SL transmission, wherein the BWP is used by the UE for SL transmission.
   For yet another sub-example, this can be applicable when the UE transits reservation information to another UE. For instance, the reservation information indicates the sub-channel in the RB-set is used by the UE for SL transmission.
   For yet another sub-example, this can be applicable when no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-)configuration. For one sub-instance, this example is applicable when the (pre-)configuration is provided.
For another sub-example, the (pre-)configuration can be a separate (pre-)configuration from a (pre-)configuration of the index for the first type of CP extension applied to SL transmission as a first transmission of a channel occupancy (e.g., not in a shared channel occupancy).
For yet another sub-example, the SL transmission can be PSSCH/PSCCH transmission.
For yet another sub-example, the SL transmission can be S-SS/PSBCH block transmission.

For yet another example, at least one index for the first type of CP extension can be provided by a (pre-)configuration. For another sub-example, the UE can select one index based on the highest SL priority of the SL transmissions and apply the corresponding CP extension to the SL transmission (e.g., the UE can select the longest CP extension that the highest SL priority of the SL transmissions can correspond to).
For one sub-example, this can be applicable when the SL transmission occupies all the RBs in a RB-set.
For another sub-example, this can be applicable when the SL transmission does not occupy all RBs in a RB-set.
   For yet another sub-example, this can be applicable when the UE doesn't receive any reservation information. For instance, the reservation information indicates another UE reserves/selects resources (e.g., an interlace or at least one RB) in the RB-set for its SL transmission, wherein the RB-set if used by the UE for SL transmission. For another instance, the reservation information indicates another UE reserves/selects resources (e.g., an interlace or at least one RB) in the sub-channel for its SL transmission, wherein the sub-channel is used by the UE for SL transmission. For yet another instance, the reservation information indicates another UE reserves/selects resources (e.g., an interlace or at least one RB) in the resource pool for its SL transmission, wherein the resource pool is used by the UE for SL transmission. For yet another instance, the reservation information indicates another UE reserves/selects resources (e.g., an interlace or at least one RB) in the BWP for its SL transmission, wherein the BWP is used by the UE for SL transmission.
   For yet another sub-example, this can be applicable when the UE transits reservation information to another UE. For instance, the reservation information indicates the sub-channel in the RB-set is used by the UE for SL transmission.
   For yet another sub-example, this can be applicable when no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-)configuration. For one sub-instance, this example is applicable when the (pre-)configuration is provided.
For another sub-example, the (pre-)configuration can be a separate (pre-)configuration from a (pre-)configuration of the index for the first type of CP extension applied to SL transmission within a channel occupancy.
For yet another sub-example, the SL transmission can be PSSCH/PSCCH transmission.
For yet another sub-example, the SL transmission can be S-SS/PSBCH block transmission.

For yet another example, if the (pre-)configuration is not provided, the UE can assume a default index for the first type of CP extension. For one instance, the default CP extension corresponding to i=3 is applied to the SL transmission. For another instance, the default CP extension corresponding to i=2 is applied to the SL transmission. For yet another instance, the default CP extension corresponding to i=1 is applied to the SL transmission. For yet another instance, the default CP extension corresponding to i=0 is applied to the SL transmission.

In yet another embodiment, the first type of CP extension can be applied to a SL transmission in a set of SL transmissions in consecutive slots (e.g., multiple consecutive slots transmission), wherein the SL transmission is not the first SL transmission in the set.

For one example, an index for the first type of CP extension can be fixed in the specification. For one instance, CP extension corresponding to i=3 is applied to the SL transmission. For another instance, CP extension corresponding to i=2 is applied to the SL transmission. For yet another instance, CP extension corresponding to i=1 is applied to the SL transmission. For yet another instance, CP extension corresponding to i=0 is applied to the SL transmission.

For another example, an index for the first type of CP extension can be provided by a (pre-)configuration.
For one sub-example, this can be applicable when the SL transmission does not occupy all RBs in a RB-set.
For another sub-example, this can be applicable when the SL transmission occupies all the RBs in a RB-set.

For yet another example, at least one index for the first type of CP extension can be provided by a (pre-)configuration. For one sub-example, the UE can randomly select one index and apply the corresponding CP extension to the SL transmission. For another sub-example, the UE can select one index based on the highest SL priority of the SL transmissions and apply the corresponding CP extension to the SL transmission (e.g., the UE can select the longest CP extension that the highest SL priority of the SL transmissions can correspond to).
For one sub-example, this can be applicable when the SL transmission occupies all the RBs in a RB-set.
For another sub-example, this can be applicable when the SL transmission does not occupy all RBs in a RB-set.
For yet another sub-example, the SL transmission can be PSSCH/PSCCH transmission.
For yet another sub-example, the SL transmission can be S-SS/PSBCH block transmission.

For yet another example, if the (pre-)configuration is not provided, the UE can assume a default index for the first type of CP extension. For one instance, the default CP extension corresponding to i=3 is applied to the SL transmission. For another instance, the default CP extension corresponding to i=2 is applied to the SL transmission. For yet another instance, the default CP extension corresponding to i=1 is applied to the SL transmission. For yet another instance, the default CP extension corresponding to i=0 is applied to the SL transmission.

In the present disclosure, an application of the second type of CP extension is provided.

In one embodiment, an index for the second type of CP extension can be included in a SCI format.

For one example, the SCI format can include channel occupancy information, wherein the channel occupancy information includes the index for the second type of CP extension.

For another example, the SCI format can also include channel occupancy information, wherein the channel occupancy information is associated with the index for the second type of CP extension.

For one example, when a UE receives the SCI format, and determines the UE is a responding UE to share the channel occupancy, the UE can apply a CP extension value to a first symbol of a next SL transmission (e.g., any SL transmission) based on the index of the second type of CP extension.

For another example, when a UE receives the SCI format, and determines the UE is a responding UE to share the channel occupancy, the UE can apply a CP extension value to a first symbol of a PSSCH/PSCCH transmission based on the index of the second type of CP extension.

For yet another example, when a UE receives the SCI format, and determines the UE is a responding UE to share the channel occupancy, the UE can apply a CP extension value to a first symbol of a PSFCH transmission based on the index of the second type of CP extension.

For yet another example, when a UE receives the SCI format, and determines the UE is a responding UE to share the channel occupancy, the UE can apply a CP extension value to a first symbol of a S-SS/PSBCH block transmission based on the index of the second type of CP extension.

In another embodiment, the second type of CP extension can be applied to a SL transmission as a first transmission in a channel occupancy initiated by the UE.

For one example, an index for the second type of CP extension can be fixed in the specification. For one instance, CP extension corresponding to i=0 is applied to the SL transmission. For another instance, CP extension corresponding to i=1 is applied to the SL transmission. For yet another instance, CP extension corresponding to i=2 is applied to the SL transmission. For yet another instance, CP extension corresponding to i=3 is applied to the SL transmission. For yet another instance, CP extension corresponding to i=4 is applied to the SL transmission. For yet another instance, CP extension corresponding to i=5 is applied to the SL transmission. For yet another instance, CP extension corresponding to i=6 is applied to the SL transmission. For yet another instance, CP extension corresponding to i=7 is applied to the SL transmission.

For another example, an index for the second type of CP extension can be provided by a (pre-)configuration.
For one sub-example, this can be applicable when the SL transmission does not occupy all RBs in a RB-set.
   For yet another sub-example, this can be applicable when the UE receives reservation information. For instance, the reservation information indicates another UE reserves/selects resources (e.g., an interlace or at least one RB) in the RB-set and the slot for its SL transmission, wherein the RB-set and/or slot is used by the UE for SL transmission. For another instance, the reservation information indicates another UE reserves/selects resources (e.g., an interlace or at least one RB) in the sub-channel for its SL transmission, wherein the sub-channel is used by the UE for SL transmission. For yet another instance, the reservation information indicates another UE reserves/selects resources (e.g., an interlace or at least one RB) in the resource pool for its SL transmission, wherein the resource pool is used by the UE for SL transmission. For yet another instance, the reservation information indicates another UE reserves/selects resources (e.g., an interlace or at least one RB) in the BWP for its SL transmission, wherein the BWP is used by the UE for SL transmission.
   For yet another sub-example, this can be applicable when the UE transits reservation information to another UE. For instance, the reservation information indicates at least one sub-channel in the RB-set and the slot is used by the UE for SL transmission.
   For yet another sub-example, this can be applicable when there is no guarantee that no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-)configuration. For one sub-instance, this example is applicable when the (pre-)configuration is not provided.
For another sub-example, this can be applicable when the SL transmission occupies all the RBs in a RB-set.
For yet another sub-example, the (pre-)configuration can be a separate (pre-) configuration from a (pre-)configuration of the index for the second type of CP extension applied to SL transmission within a channel occupancy.
For yet another sub-example, the SL transmission can be PSSCH/PSCCH transmission.
For yet another sub-example, the SL transmission can be S-SS/PSBCH block transmission.

For yet another example, at least one index for the second type of CP extension can be provided by a (pre-)configuration. For one sub-example, the UE can randomly select one index and apply the corresponding CP extension to the SL transmission. For another sub-example, the UE can select one index based on the highest SL priority of the SL transmissions and apply the corresponding CP extension to the SL transmission (e.g., the UE can select the longest CP extension that the highest SL priority of the SL transmissions can correspond to).
For one sub-example, this can be applicable when the SL transmission occupies all the RBs in a RB-set.
For another sub-example, this can be applicable when the SL transmission does not occupy all RBs in a RB-set.
   For yet another sub-example, this can be applicable when the UE doesn't receive any reservation information. For instance, the reservation information indicates another UE reserves/selects resources (e.g., an interlace or at least one RB) in the RB-set and the slot for its SL transmission, wherein the RB-set and/or the slot is used by the UE for SL transmission. For another instance, the reservation information indicates another UE reserves/selects resources (e.g., an interlace or at least one RB) in the sub-channel for its SL transmission, wherein the sub-channel is used by the UE for SL transmission. For yet another instance, the reservation information indicates another UE reserves/selects resources (e.g., an interlace or at least one RB) in the resource pool for its SL transmission, wherein the resource pool is used by the UE for SL transmission. For yet another instance, the reservation information indicates another UE reserves/selects resources (e.g., an interlace or at least one RB) in the BWP for its SL transmission, wherein the BWP is used by the UE for SL transmission.
   For yet another sub-example, this can be applicable when the UE does not transit reservation information to another UE. For instance, the reservation information indicates at least one sub-channel in the RB-set and the slot is used by the UE for SL transmission.
   For yet another sub-example, this can be applicable when no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-)configuration. For one sub-instance, this example is applicable when the (pre-)configuration is provided.
For another sub-example, the (pre-)configuration can be a separate (pre-)configuration from a (pre-)configuration of the index for the second type of CP extension applied to SL transmission within a channel occupancy.
For yet another sub-example, the SL transmission can be PSSCH/PSCCH transmission.
For yet another sub-example, the SL transmission can be S-SS/PSBCH block transmission.

For yet another example, at least one index for the second type of CP extension can be provided by a (pre-)configuration. For one sub-example, the UE can select one index based on the highest SL priority of the SL transmissions and apply the corresponding CP extension to the SL transmission (e.g., the UE can select the longest CP extension that the highest SL priority of the SL transmissions can correspond to).
For one sub-example, this can be applicable when the SL transmission occupies all the RBs in a RB-set.
For another sub-example, this can be applicable when the SL transmission does not occupy all RBs in a RB-set.
   For yet another sub-example, this can be applicable when the UE receives reservation information. For instance, the reservation information indicates another UE reserves/selects resources (e.g., an interlace or at least one RB) in the RB-set and the slot for its SL transmission, wherein the RB-set and/or the slot is used by the UE for SL transmission. For another instance, the reservation information indicates another UE reserves/selects resources (e.g., an interlace or at least one RB) in the sub-channel for its SL transmission, wherein the sub-channel is used by the UE for SL transmission. For yet another instance, the reservation information indicates another UE reserves/selects resources (e.g., an interlace or at least one RB) in the resource pool for its SL transmission, wherein the resource pool is used by the UE for SL transmission. For yet another instance, the reservation information indicates another UE reserves/selects resources (e.g., an interlace or at least one RB) in the BWP for its SL transmission, wherein the BWP is used by the UE for SL transmission.
   For yet another sub-example, this can be applicable when the UE transits reservation information to another UE. For instance, the reservation information indicates at least one sub-channel in the RB-set and the slot is used by the UE for SL transmission.
   For yet another sub-example, this can be applicable when there is no guarantee that no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-)configuration. For one sub-instance, this example is applicable when the (pre-)configuration is not provided.
For another sub-example, the (pre-)configuration can be a separate (pre-)configuration from a (pre-)configuration of the index for the second type of CP extension applied to SL transmission within a channel occupancy.
For yet another sub-example, the SL transmission can be PSSCH/PSCCH transmission.
For yet another sub-example, the SL transmission can be S-SS/PSBCH block transmission.

For yet another example, if the (pre-)configuration is not provided, the UE can assume a default index for the second type of CP extension. For one instance, the default CP extension corresponding to i=0 is applied to the SL transmission (e.g., the resulting gap is 16 us). For another instance, the default CP extension corresponding to i=1 is applied to the SL transmission (e.g., the resulting gap is 25 us). For yet another instance, the default CP extension corresponding to i=2 is applied to the SL transmission (e.g., the resulting gap is 34 us). For yet another instance, the default CP extension corresponding to i=3 is applied to the SL transmission (e.g., the resulting gap is 43 us). For yet another instance, the default CP extension corresponding to i=4 is applied to the SL transmission (e.g., the resulting gap is 52 us). For yet another instance, the default CP extension corresponding to i=5 is applied to the SL transmission (e.g., the resulting gap is 61 us). For yet another instance, the default CP extension corresponding to i=6 is applied to the SL transmission (e.g., no CP extension). For yet another instance, the default CP extension corresponding to i=7 is applied to the SL transmission (e.g., the resulting gap is 0 us).

In yet another embodiment, the second type of CP extension can be applied to a SL transmission within a channel occupancy, e.g., shared by another UE or from the same UE initiates the channel occupancy, wherein the SL transmission is not the first SL transmission in the channel occupancy (e.g., the first SL transmission is from the UE initiating the channel occupancy).

For one example, an index for the second type of CP extension can be fixed in the specification. For one instance, CP extension corresponding to i=0 is applied to the SL transmission. For another instance, CP extension corresponding to i=1 is applied to the SL transmission. For yet another instance, CP extension corresponding to i=2 is applied to the SL transmission. For yet another instance, CP extension corresponding to i=3 is applied to the SL transmission. For yet another instance, CP extension corresponding to i=4 is applied to the SL transmission. For yet another instance, CP extension corresponding to i=5 is applied to the SL transmission. For yet another instance, CP extension corresponding to i=6 is applied to the SL transmission. For yet another instance, CP extension corresponding to i=7 is applied to the SL transmission.

For another example, an index for the second type of CP extension can be provided by a (pre-)configuration.
For one sub-example, this can be applicable when the SL transmission does not occupy all RBs in a RB-set.
   For yet another sub-example, this can be applicable when the UE receives reservation information. For instance, the reservation information indicates another UE reserves/selects resources (e.g., an interlace or at least one RB) in the RB-set and the slot for its SL transmission, wherein the RB-set and/or the slot is used by the UE for SL transmission. For another instance, the reservation information indicates another UE reserves/selects resources (e.g., an interlace or at least one RB) in the sub-channel for its SL transmission, wherein the sub-channel is used by the UE for SL transmission. For yet another instance, the reservation information indicates another UE reserves/selects resources (e.g., an interlace or at least one RB) in the resource pool for its SL transmission, wherein the resource pool is used by the UE for SL transmission. For yet another instance, the reservation information indicates another UE reserves/selects resources (e.g., an interlace or at least one RB) in the BWP for its SL transmission, wherein the BWP is used by the UE for SL transmission.
   For yet another sub-example, this can be applicable when the UE transits reservation information to another UE. For instance, the reservation information indicates at least one sub-channel in the RB-set and the slot is used by the UE for SL transmission.
   For yet another sub-example, this can be applicable when there is no guarantee that no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-)configuration. For one sub-instance, this example is applicable when the (pre-)configuration is not provided.
For another sub-example, this can be applicable when the SL transmission occupies all the RBs in a RB-set.
For yet another sub-example, the (pre-)configuration can be a separate (pre-) configuration from a (pre-)configuration of the index for the second type of CP extension applied to SL transmission as a first transmission of a channel occupancy (e.g., not in a shared channel occupancy).
For yet another sub-example, the SL transmission can be PSSCH/PSCCH transmission.
For yet another sub-example, the SL transmission can be S-SS/PSBCH block transmission.

For yet another example, at least one index for the second type of CP extension can be provided by a (pre-)configuration. For one sub-example, the UE can randomly select one index and apply the corresponding CP extension to the SL transmission. For another sub-example, the UE can select one index based on the highest SL priority of the SL transmissions and apply the corresponding CP extension to the SL transmission (e.g., the UE can select the longest CP extension that the highest SL priority of the SL transmissions can correspond to).
For one sub-example, this can be applicable when the SL transmission occupies all the RBs in a RB-set.
For another sub-example, this can be applicable when the SL transmission does not occupy all RBs in a RB-set.
   For yet another sub-example, this can be applicable when the UE does not receive any reservation information. For instance, the reservation information indicates another UE reserves/selects resources (e.g., an interlace or at least one RB) in the RB-set and the slot for its SL transmission, wherein the RB-set and/or the slot is used by the UE for SL transmission. For another instance, the reservation information indicates another UE reserves/selects resources (e.g., an interlace or at least one RB) in the sub-channel for its SL transmission, wherein the sub-channel is used by the UE for SL transmission. For yet another instance, the reservation information indicates another UE reserves/selects resources (e.g., an interlace or at least one RB) in the resource pool for its SL transmission, wherein the resource pool is used by the UE for SL transmission. For yet another instance, the reservation information indicates another UE reserves/selects resources (e.g., an interlace or at least one RB) in the BWP for its SL transmission, wherein the BWP is used by the UE for SL transmission.
   For yet another sub-example, this can be applicable when the UE does not transit reservation information to another UE. For instance, the reservation information indicates at least one sub-channel in the RB-set and the slot is used by the UE for SL transmission.
   For yet another sub-example, this can be applicable when no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-)configuration. For one sub-instance, this example is applicable when the (pre-)configuration is provided.
For another sub-example, the (pre-)configuration can be a separate (pre-)configuration from a (pre-)configuration of the index for the second type of CP extension applied to SL transmission as a first transmission of a channel occupancy (e.g., not in a shared channel occupancy).
For yet another sub-example, the SL transmission can be PSSCH/PSCCH transmission.
For yet another sub-example, the SL transmission can be S-SS/PSBCH block transmission.

For yet another example, at least one index for the second type of CP extension can be provided by a (pre-)configuration. For another sub-example, the UE can select one index based on the highest SL priority of the SL transmissions and apply the corresponding CP extension to the SL transmission (e.g., the UE can select the longest CP extension that the highest SL priority of the SL transmissions can correspond to).
For one sub-example, this can be applicable when the SL transmission occupies all the RBs in a RB-set.
For another sub-example, this can be applicable when the SL transmission does not occupy all RBs in a RB-set.
   For yet another sub-example, this can be applicable when the UE receives reservation information. For instance, the reservation information indicates another UE reserves/selects resources (e.g., an interlace or at least one RB) in the RB-set and the slot for its SL transmission, wherein the RB-set and/or the slot is used by the UE for SL transmission. For another instance, the reservation information indicates another UE reserves/selects resources (e.g., an interlace or at least one RB) in the sub-channel for its SL transmission, wherein the sub-channel is used by the UE for SL transmission. For yet another instance, the reservation information indicates another UE reserves/selects resources (e.g., an interlace or at least one RB) in the resource pool for its SL transmission, wherein the resource pool is used by the UE for SL transmission. For yet another instance, the reservation information indicates another UE reserves/selects resources (e.g., an interlace or at least one RB) in the BWP for its SL transmission, wherein the BWP is used by the UE for SL transmission.
   For yet another sub-example, this can be applicable when the UE transits reservation information to another UE. For instance, the reservation information indicates at least one sub-channel and the slot in the RB-set is used by the UE for SL transmission.
   For yet another sub-example, this can be applicable when there is no guarantee that no other RAT (e.g., NR-U) coexists on the same carrier or BWP or resource pool (e.g., in a long term by regulation), e.g., no transmission from other RAT overlapping with the carrier or BWP or resource pool for SL transmission. For instance, such information on no other RAT coexists on the same carrier or BWP or resource pool can be provided by a (pre-)configuration. For one sub-instance, this example is applicable when the (pre-)configuration is not provided.
For another sub-example, the (pre-)configuration can be a separate (pre-)configuration from a (pre-)configuration of the index for the second type of CP extension applied to SL transmission as a first transmission of a channel occupancy (e.g., not in a shared channel occupancy).
For yet another sub-example, the SL transmission can be PSSCH/PSCCH transmission.
For yet another sub-example, the SL transmission can be S-SS/PSBCH block transmission.

For yet another example, if the (pre-)configuration is not provided, the UE can assume a default index for the second type of CP extension. For one instance, the default CP extension corresponding to i=0 is applied to the SL transmission (e.g., the resulting gap is 16 us). For another instance, the default CP extension corresponding to i=1 is applied to the SL transmission (e.g., the resulting gap is 25 us). For yet another instance, the default CP extension corresponding to i=2 is applied to the SL transmission (e.g., the resulting gap is 34 us). For yet another instance, the default CP extension corresponding to i=3 is applied to the SL transmission (e.g., the resulting gap is 43 us). For yet another instance, the default CP extension corresponding to i=4 is applied to the SL transmission (e.g., the resulting gap is 52 us). For yet another instance, the default CP extension corresponding to i=5 is applied to the SL transmission (e.g., the resulting gap is 61 us). For yet another instance, the default CP extension corresponding to i=6 is applied to the SL transmission (e.g., no CP extension). For yet another instance, the default CP extension corresponding to i=7 is applied to the SL transmission (e.g., the resulting gap is 0 us).

In yet another embodiment, the second type of CP extension can be applied to a SL transmission in a set of SL transmissions in consecutive slots (e.g., multiple consecutive slots transmission), wherein the SL transmission is not the first SL transmission in the set. For one further consideration, the gap between consecutive slots for SL transmission can be one symbol.
For yet another sub-example, the SL transmission can be PSSCH/PSCCH transmission.
For yet another sub-example, the SL transmission can be S-SS/PSBCH block transmission. For one example, an index for the second type of CP extension can be fixed in the specification. For one instance, CP extension corresponding to i=0 is applied to the SL transmission (e.g., the resulting gap is 16 us). For another instance, CP extension corresponding to i=1 is applied to the SL transmission (e.g., the resulting gap is 25 us). For yet another instance, CP extension corresponding to i=2 is applied to the SL transmission (e.g., the resulting gap is 34 us). For yet another instance, CP extension corresponding to i=3 is applied to the SL transmission (e.g., the resulting gap is 43 us). For yet another instance, CP extension corresponding to i=4 is applied to the SL transmission (e.g., the resulting gap is 52 us). For yet another instance, CP extension corresponding to i=5 is applied to the SL transmission (e.g., the resulting gap is 61 us). For yet another instance, CP extension corresponding to i=6 is applied to the SL transmission (e.g., no CP extension). For yet another instance, CP extension corresponding to i=7 is applied to the SL transmission (e.g., the resulting gap is 0 us).

For another example, an index for the second type of CP extension can be provided by a (pre-)configuration.
For one sub-example, this can be applicable when the SL transmission does not occupy all RBs in a RB-set.
For another sub-example, this can be applicable when the SL transmission occupies all the RBs in a RB-set.

For yet another example, at least one index for the second type of CP extension can be provided by a (pre-)configuration. For one sub-example, the UE can randomly select one index and apply the corresponding CP extension to the SL transmission. For another sub-example, the UE can select one index based on the highest SL priority of the SL transmissions and apply the corresponding CP extension to the SL transmission (e.g., the UE can select the longest CP extension that the highest SL priority of the SL transmissions can correspond to).
For one sub-example, this can be applicable when the SL transmission occupies all the RBs in a RB-set.
For another sub-example, this can be applicable when the SL transmission does not occupy all RBs in a RB-set.
For yet another sub-example, the SL transmission can be PSSCH/PSCCH transmission.
For yet another sub-example, the SL transmission can be S-SS/PSBCH block transmission.

For yet another example, if the (pre-)configuration is not provided, the UE can assume a default index for the second type of CP extension. For one instance, the default CP extension corresponding to i=0 is applied to the SL transmission. For another instance, the default CP extension corresponding to i=1 is applied to the SL transmission. For yet another instance, the default CP extension corresponding to i=2 is applied to the SL transmission. For yet another instance, the default CP extension corresponding to i=3 is applied to the SL transmission. For yet another instance, the default CP extension corresponding to i=4 is applied to the SL transmission. For yet another instance, the default CP extension corresponding to i=5 is applied to the SL transmission. For yet another instance, the default CP extension corresponding to i=6 is applied to the SL transmission. For yet another instance, the default CP extension corresponding to i=7 is applied to the SL transmission.

In the present disclosure, a condition for no CP extension is provided.

For one example, when a UE has a set of SL transmissions, and the channel is not sensed to be idle in a first channel access procedure before the first SL transmission in the set of SL transmissions, if the channel is sensed to be idle in a second channel access procedure before another SL transmission within the set of SL transmission, the UE can perform the other SL transmission without applying a CP extension.
In one sub-example, the set of SL transmissions can be contiguous.
In another sub-example, the set of SL transmissions can be non-contiguous.

For another example, when a UE has a set of SL transmissions, the UE may not apply a CP extension for the remaining SL transmissions in the set after the first SL transmission, after accessing the channel using a channel access procedure.

For yet another example, when a UE has a set of SL transmissions, and if the UE stops transmitting during or before one of these SL transmissions in the set of SL transmissions and prior to the last SL transmission, the UE may transmit a later SL transmission in the set without applying a CP extension upon the channel is sensed to be idle using a channel access procedure before the later SL transmission.

For yet another example, when a UE has two starting symbols for transmitting PSSCH/PSCCH in a slot, and if the channel is not sensed as idle in a first channel access procedure before the first starting symbol, the UE can transmit the PSSCH/PSCCH from the second starting symbol without applying a CP extension, upon the channel is sensed to be idle using a second channel access procedure before the second starting symbol.

For yet another example, when a UE has a set of transmission occasions for a SL transmission, and the channel is not sensed to be idle in a first channel access procedure before the first transmission occasion in the set, if the channel is sensed to be idle in a second channel access procedure before another transmission occasion in the set, the UE can perform the SL transmission without applying a CP extension using the other transmission occasion.

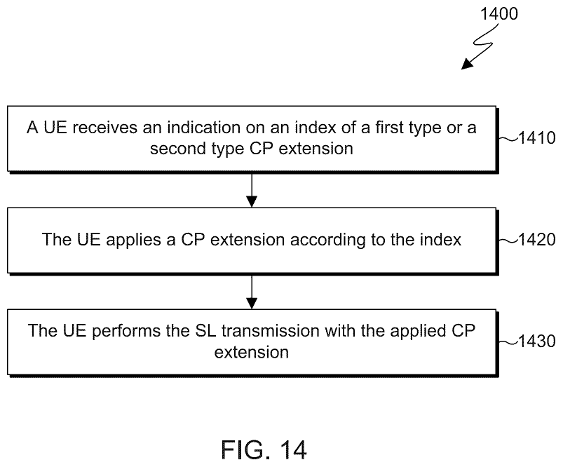

FIG. 14 illustrates a flowchart of an example UE procedure 1400 according to embodiments of the present disclosure. The UE procedure 1400 may be performed by a UE (e.g., any of the UEs 111-116 as illustrated in FIG. 1). An embodiment of the UE procedure 1400 shown in FIG. 14 is for illustration only and does not limit the scope of this disclosure to any particular implementation.

As shown in FIG. 14, the example UE procedure 1400 begins at step 1410, where a UE (such as the UE 116) receives an indication on an index of a first type or a second type CP extension. At step 1420, the UE applies a CP extension according to the index. At step 1430, the UE performs the SL transmission with the applied CP extension.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
determine, based on higher layer parameters, a number of candidate starting symbols for a physical sidelink shared channel (PSSCH) in a slot;
determine a number of sidelink symbols (N_{symb}^{sh}) within a slot based on the number of candidate starting symbols for the PSSCH;
determine, based on the number of sidelink symbols, a first number of resource elements (REs) (N_{RE}′) allocated for the PSSCH within a physical resource block (PRB);
determine a number of PRBs (n_{PRB}) allocated for the PSSCH; and
determine a second number of REs (N_{RE}) allocated for the PSSCH based on (i) the first number of REs allocated for the PSSCH within the PRB and (ii) the number of PRBs allocated for the PSSCH; and
a transceiver operably coupled to the processor, the transceiver configured to receive the PSSCH based on the second number of REs allocated for the PSSCH.

2. The UE of claim 1, wherein:
the number of candidate starting symbols for the PSSCH is determined as 2, when two candidate starting symbol indexes are provided by the higher layer parameters; and
the number of candidate starting symbols for the PSSCH is determined as 1, otherwise.

3. The UE of claim 1, wherein:
N_{symb}^{sh}=I₁−2, when the number of candidate starting symbols for the PSSCH is 1, wherein I₁ is a first number of symbols and provided by a first higher layer parameter; and
N_{symb}^{sh}=I₂−2, when the number of candidate starting symbols for the PSSCH is 2, wherein I₂ is a second number of symbols and provided by a second higher layer parameter.

4. The UE of claim 1, wherein, when the PSSCH is based on interlaced resource blocks (RBs), n_{PRB}=N_{RB-set}·N_{sub-channel}·Nᵢₙₜ^{sub-channel}·N_{RB}^{s,i}, where:
N_{RB-set} is a number of occupied resource block sets (RB-sets) for the PSSCH;
N_{sub-channel} is a number of allocated sub-channels in a RB-set for the PSSCH;
Nᵢₙₜ^{sub-channel} is a number of interlaces in a sub-channel; and
N_{RB}^{s,i} is a number of RBs in an interlace and the number of RBs is provided by a higher layer parameter.

5. The UE of claim 1, wherein, when the PSSCH is based on contiguous resource blocks (RBs), n_{PRB}=N_{sub-channel}·N_{RB}, where:
N_{sub-channel} is a number of allocated sub-channels for the PSSCH, and
N_{RB} is a number of RBs in a sub-channel.

6. The UE of claim 1, wherein the processor is configured to:
determine a cyclic prefix (CP) extension value for a sidelink symbol in a sidelink transmission as
$$\\ {T}_{ext} = {\sum }_{k = 1}^{C} {T}_{sym b , ( l - k ) mod 7 \cdot {2}^{{}_{} μ}}^{{}_{} μ} - {Δ}_{i}$$
where:
Δᵢ takes a value from 16·10⁻⁶, 25·10⁻⁶, 34·10⁻⁶, 43·10⁻⁶, 52·10⁻⁶, 61·10⁻⁶, or Σₖ₌₁^{C} T_{symb,(l-k)mod 7·2}_{^{μ}}^{μ}; and
C takes a value from 1 or 2 for μ=1 or 2, and takes a value of 1 for μ=0.

7. The UE of claim 6, wherein, when the sidelink transmission is in a set of multiple consecutive transmissions and not a first transmission in the set, a CP extension value is applied such that a gap from a previous transmission is 16 microseconds (us).

8. The UE of claim 6, wherein, when the sidelink transmission (i) is a first transmission in a channel occupancy initiated by the UE and (ii) includes a physical sidelink control channel (PSCCH) or PSSCH, the CP extension value of the sidelink transmission is:
randomly selected from a set of values provided by a first higher layer parameter, when the UE does not receive reservation information that any of resource block sets (RB-sets) for the PSSCH is occupied by another UE; or
provided by a second higher layer parameter, otherwise.

9. The UE of claim 8, wherein, when the sidelink transmission (i) is a transmission in the channel occupancy other than the first transmission and (ii) includes the PSCCH or PSSCH, the CP extension value of the sidelink transmission is:
randomly selected from a set of values provided by a third higher layer parameter, when the UE does not receive reservation information that any of resource block sets (RB-sets) for the PSSCH is occupied by the other UE; or
provided by a fourth higher layer parameter, otherwise.

10. The UE of claim 9, wherein, when the sidelink transmission is a sidelink synchronization signals and physical sidelink broadcast channel block (S-SS/PSBCH block), the CP extension value of the sidelink transmission is provided by a fifth higher layer parameter.

11. A method of a user equipment (UE) in a wireless communication system, the method comprising:
determining, based on higher layer parameters, a number of candidate starting symbols for a physical sidelink shared channel (PSSCH) in a slot;
determining a number of sidelink symbols (N_{symb}^{sh}) within a slot based on the number of candidate starting symbols for the PSSCH;
determining, based on the number of sidelink symbols, a first number of resource elements (RES) (N_{RE}′) allocated for the PSSCH within a physical resource block (PRB);
determining a number of PRBs (n_{PRB}) allocated for the PSSCH;
determining a second number of REs (N_{RE}) allocated for the PSSCH based on (i) the number of REs allocated for the PSSCH within a PRB and (ii) the number of PRBs allocated for the PSSCH; and
receiving the PSSCH based on the second number of REs allocated for the PSSCH.

12. The method of claim 11, wherein:
the number of candidate starting symbols for the PSSCH is determined as 2, when two candidate starting symbol indexes are provided by the higher layer parameters; and
the number of candidate starting symbols for the PSSCH is determined as 1, otherwise.

13. The method of claim 11, wherein:
N_{symb}^{sh}=I₁−2, when the number of candidate starting symbols for the PSSCH is 1, wherein I₁ is a first number of symbols and provided by a first higher layer parameter; and
N_{symb}^{sh}=I₂−2, when the number of candidate starting symbols for the PSSCH is 2, wherein I₂ is a second number of symbols and provided by a second higher layer parameter.

14. The method of claim 11, wherein, when the PSSCH is based on interlaced resource blocks (RBs), n_{PRB}=N_{RB-set}·N_{sub-channel}·Nᵢₙₜ^{sub-channel}·N_{RB}^{s,i}, where:
N_{RB-set} is a number of occupied resource block sets (RB-sets) for the PSSCH;
N_{sub-channel} is a number of allocated sub-channels in a RB-set for the PSSCH;
Nᵢₙₜ^{sub-channel} is a number of interlaces in a sub-channel; and
N_{RB}^{s,i} is a number of RBs in an interlace and the number of RBs is provided by a higher layer parameter.

15. The method of claim 11, wherein, when the PSSCH is based on contiguous resource blocks (RBs), n_{PRB}=N_{sub-channel}·N_{RB}, where:
N_{sub-channel} is a number of allocated sub-channels for the PSSCH, and
N_{RB} is a number of RBs in a sub-channel.

16. The method of claim 11, further comprising:
determining a cyclic prefix (CP) extension value for a sidelink symbol in a sidelink transmission as
$$\\ {T}_{ext} = {\sum }_{k = 1}^{C} {T}_{sym b , ( l - k ) mod 7 \cdot {2}^{{}_{} μ}}^{{}_{} μ} - {Δ}_{i}$$
where:
Δᵢ takes a value from 16·10⁻⁶, 25·10⁻⁶, 34·10⁻⁶, 43·10⁻⁶, 52·10⁻⁶, 61·10⁻⁶, or Σₖ₌₁^{C} T_{symb,(l-k)mod 7·2}_{^{μ}}^{μ}; and
C takes a value from 1 or 2 for μ=1 or 2, and takes a value of 1 for μ=0.

17. The method of claim 16, wherein when the sidelink transmission is in a set of multiple consecutive transmissions and not a first transmission in the set, a CP extension value is applied such that a gap from a previous transmission is 16 microseconds (us).

18. The method of claim 16, wherein, when the sidelink transmission is (i) a first transmission in a channel occupancy initiated by the UE and (ii) includes a physical sidelink control channel (PSCCH) or PSSCH, the CP extension value of the sidelink transmission is:
randomly selected from a set of values provided by a first higher layer parameter, when the UE does not receive reservation information that any of resource block sets (RB-sets) for the PSSCH is occupied by another UE; or
provided by a second higher layer parameter, otherwise.

19. The method of claim 18, wherein, when the sidelink transmission (i) is a transmission in the channel occupancy other than the first transmission and (ii) includes the PSCCH or PSSCH, the CP extension value of the sidelink transmission is:
randomly selected from a set of values provided by a third higher layer parameter, when the UE does not receive reservation information that any of resource block sets (RB-sets) for the PSSCH is occupied by the other UE; or
provided by a fourth higher layer parameter, otherwise.

20. The method of claim 19, wherein, when the sidelink transmission is a sidelink synchronization signals and physical sidelink broadcast channel block (S-SS/PSBCH block), the CP extension value of the sidelink transmission is provided by a fifth higher layer parameter.
